(19) United States
(12) Patent Application Publication
(10) Pub. No.: US 2010/0085950 A1
(43) Pub. Date: Apr. 8, 2010

(54) WIRELESS COMMUNICATION DEVICE AND WIRELESS COMMUNICATION METHOD

(76) Inventors: Masahiro Sekiya, Inagi-shi (JP); Daisuke Taki, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/559,028

(22) Filed: Sep. 14, 2009

(30) Foreign Application Priority Data
Oct. 7, 2008 (JP) 2008-260795

(51) Int. Cl. H04W 4/00

(52) U.S. Cl. 370/338

(57) ABSTRACT

A wireless communication device includes a physical layer protocol processor which can transmit and receive data by first to Nth communication schemes, where ith communication scheme has compatibility with the first to (i−1)th communication scheme. A first controller generates a first frame for forbidding communication by the first to Nth communication schemes for a first period, and orders the physical layer protocol processor to transmit the first frame by the first communication scheme. A second controller generates a second frame for lifting the forbiddance on communication, and orders the physical layer protocol processor to transmit the second frame by a jth communication scheme. A third controller generates a third frame for forbidding communication by a (j+1)th to Nth communication schemes for a second period, and orders the physical layer protocol processor to transmit the third frame by the (j+1)th communication scheme.

### CROSS-REFERENCE TO RELATED APPLICATIONS

This application is based upon and claims the benefit of priority from prior Japanese Patent Application No. 2008-260795, filed Oct. 7, 2008, the entire contents of which are incorporated herein by reference.

### BACKGROUND OF THE INVENTION

1. Field of the Invention

The present invention relates to a wireless communication device and a wireless communication method, and in particular to a radio communication system in which communication by several wireless communication systems is possible.

2. Description of the Related Art

In the wireless LAN based on the Institute of Electrical and Electronics Engineers (IEEE) 802.11 standard, the protocol in the physical layer has mainly been changed to improve the data transmission speed. As a result, commercially-available wireless communication devices include those that support a new wireless LAN standard, and those that support an old wireless LAN standard.

Recent wireless LAN standards require that devices be backward compatible. However, the wireless terminals of the existing standard cannot demodulate packets of a new standard. For this reason, allowing wireless terminals conforming to several standards to use one frequency channel to communicate requires a system which ensures that a wireless terminal of one standard does not interfere with communication of another wireless terminal of another standard.

A system which enables coexistence of the IEEE 802.11b standard and the IEEE 802.11g standard has previously been specified (see IEEE 802.11-2007). However, this method requires the transmission of the Clear to Send (CTS) frame upon every transmission of a data frame. This complicates the processing.

The conventional systems for coexistence include a system which allows for an exclusive communication period by addition of a new identifier into the frame specified by the existing standards (for example, see a Jpn. Pat. Appln. KOKAI Publication No. 2005-341532). However, this system requires modifications to be made to the wireless terminals which support the existing standards. This is troublesome.

Moreover, another method can grant an exclusive communication period to the wireless terminals which support a new communication scheme, but cannot grant an exclusive communication period to wireless terminals which support only the existing communication scheme (for example, see Jpn. Pat. Appln. KOKAI Publication No. 2006-014258). Therefore, communication opportunities for the wireless terminals which support the existing communication scheme may not be fully secured.

### BRIEF SUMMARY OF THE INVENTION

According to an aspect of the present invention, there is provided a wireless communication device comprising: a physical layer protocol processor which is able to transmit and receive data by a first to Nth communication schemes (N being a natural number of two or more), an ith communication scheme (i being a natural number between two and N) having compatibility with the first to (i−1)th communication scheme; a first controller which generates a first frame for forbidding communication by the first to Nth communication schemes for a first period, and orders the physical layer protocol processor to transmit the first frame by the first communication scheme; a second controller which generates a second frame for lifting the forbiddance on communication by the first frame, and orders the physical layer protocol processor to transmit the second frame by a jth communication scheme (j being a natural number of N−1 or less); and

a third controller which generates a third frame for forbidding communication by a (j+1)th to Nth communication schemes for a second period, and orders the physical layer protocol processor to transmit the third frame by the (j+1)th communication scheme.

According to another aspect of the present invention, there is provided a wireless communication method performed in wireless communication devices which are able to communicate by a first to Nth communication schemes (N being a natural number of two or more), an ith communication scheme (i being a natural number between two and N) having compatibility with the first to (i−1)th communication schemes, the method comprising: transmitting a first frame for forbidding communication by the first communication scheme; after the transmission of a first frame, transmitting a second frame for lifting the forbiddance of communication by a jth communication scheme (j being a natural number of N−1 or less); after the transmission of a second frame, transmitting the first frame by a (j+1)th communication scheme; and after the transmission of a first frame by a (j+1)th communication scheme, communicating by the jth communication scheme.

### BRIEF DESCRIPTION OF THE SEVERAL VIEWS OF THE DRAWING

FIG. 1 shows a block diagram of the wireless LAN system according to the first embodiment of the present invention.

FIG. 2 shows a block diagram of the wireless LAN base station according to the first embodiment.

FIG. 3 schematically shows the configuration of a frame.

FIG. 4 shows a flow chart of the wireless communication scheme according to the first embodiment.

FIG. 5 shows a timing chart of the transmission and reception of the frames in the wireless LAN system according to the first embodiment.

FIG. 6 schematically shows the configuration of a CTS frame.

FIG. 7 schematically shows the configuration of a CF-End frame.

FIG. 8 shows a block diagram of the wireless LAN system according to the second embodiment of the present invention.

FIG. 9 shows a timing chart for the transmission and reception of the frames in the wireless LAN system according to a second embodiment.

FIG. 10 schematically shows the configuration of a beacon frame.

FIG. 11 shows a timing chart of the relation between the beacon frames and the contention free periods (CFPs).

FIG. 12 shows a timing chart of the transmission and reception of the frame in the wireless LAN system according to the third embodiment of the present invention.

FIG. 13 shows a block diagram of the wireless LAN system according to the fourth embodiment of the present invention.

FIG. 14 shows the frequency band used by the wireless LAN base station according to the fourth embodiment.

FIG. 15 shows a timing chart of the transmission and reception of the frames in the wireless LAN system according to the fourth embodiment.

FIG. 16 shows a block diagram of the wireless LAN system according to the fifth embodiment of the present invention.

FIG. 17 schematically shows the configuration of a frame.

FIG. 18 shows a timing chart of the transmission and reception of the frames in the wireless LAN system according to the fifth embodiment.

FIG. 19 shows a timing chart of the transmission and reception of the frames in the wireless LAN system according to a modified second embodiment.

FIG. 20 shows a timing chart of the transmission and reception of the frames in the wireless LAN system according to a modified fourth embodiment.

FIG. 21 shows a block diagram of the wireless LAN system according to the first to fifth embodiments.

FIG. 22 shows a flow chart of the wireless communication scheme according to the first to fifth embodiments.

FIG. 23 shows a timing chart of the transmission and reception of the frames in the wireless LAN system according to the first to fifth embodiments.

FIG. 24 shows another timing chart of the transmission and reception of the frames in the wireless LAN system according to the second embodiment.

FIG. 25 shows a block diagram of the wireless LAN system according to a modified third embodiment.

FIG. 26 shows the frequency band used by the wireless LAN base station according to a modified third embodiment.

FIG. 27 shows a timing chart of the transmission and reception of the frames in the wireless LAN system according to a modified third embodiment.

### DETAILED DESCRIPTION OF THE INVENTION

The embodiments of the present invention will now be described with reference to the drawings. In this description, common components are labeled with the same reference numerals throughout the figures.

### First Embodiment

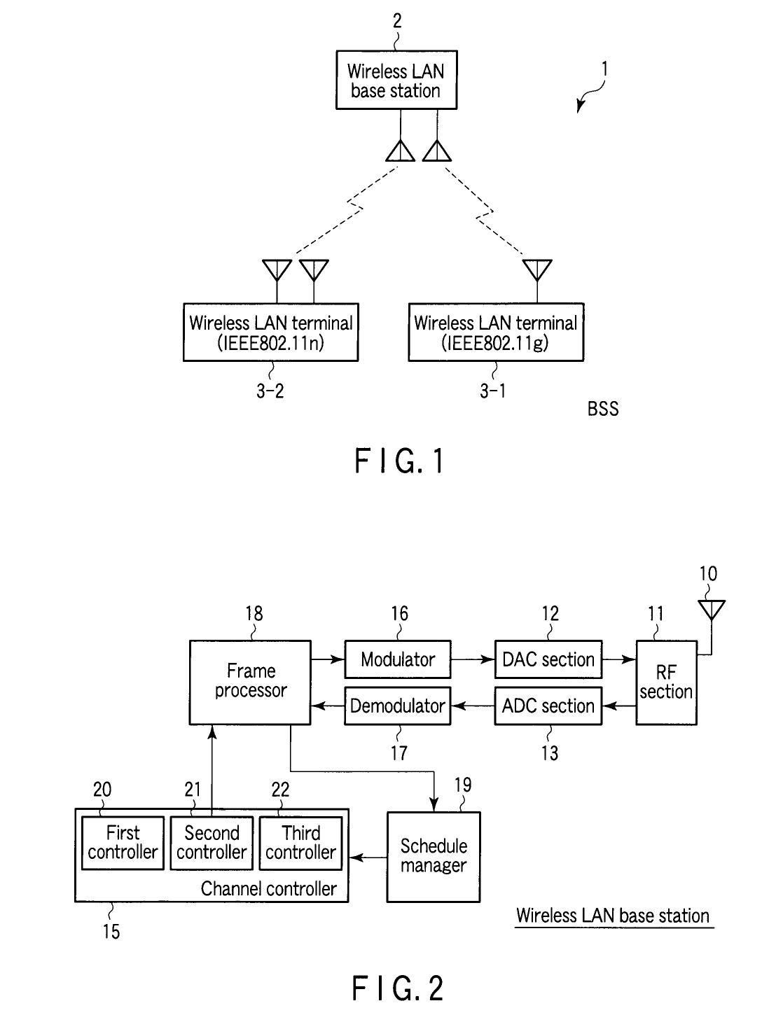

The wireless communication device and wireless communication method according to the first embodiment of the present invention will be described with reference to FIG. 1. FIG. 1 shows a block diagram of the wireless LAN system according to this embodiment.

### <Configuration of a Wireless LAN System>

As shown, the wireless LAN system 1 includes the wireless LAN base station (hereinafter referred to as an access point) 2, and wireless LAN terminals (hereinafter referred to as a terminal) 3-1 and 3-2. They constitute a wireless LAN. In the following description, terminals 3-1 and 3-2 may be referred to as the first terminal 3-1 and the second terminal 3-2, respectively. Further, when the first and terminal and second terminals 3-1 and 3-2 do not need to be distinguished, they are only referred to as the terminal 3.

Both the access point 2 and second terminal 3-2 support the communication scheme specified by IEEE 802.11n. First terminal 3-1 supports the communication scheme specified by IEEE 802.11g. The access point 2 and second terminal 3-2 which support IEEE 802.11n are backward compatible, and therefore can transmit and receive radio signals in accordance with the communication scheme specified by IEEE 802.11g. As shown in FIG. 1, a unit which access point 2 and terminals 3 accommodated by it constitute is referred to as a basic service set (BSS) in IEEE 802.11.

### <Configuration of the Access Point 2>

The configuration of the access point 2 will be described with reference to FIG. 2. FIG. 2 shows a block diagram of the access point 2.

The access point 2 is a wireless communication device based on IEEE 802.11, which includes IEEE 802.11a, IEEE 802.11b, IEEE 802.11g, and IEEE 802.11n. The access point 2 basically includes the antenna 10, radio frequency (RF) section 11, digital-to-analog converter 12, analog-to-digital converter 13, channel controller 15, modulator 16, demodulator 17, frame processor 18, and schedule manager 19. The modulator 16 and demodulator 17 perform the processing regarding the physical layer, and can be referred to as a physical layer protocol processor. The channel controller 15, frame processor 18, and schedule manager 19 perform the processing regarding the medium access control (MAC) layer, and it can be referred to as a MAC protocol processor.

The antenna 10 receives an analog radio signal transmitted in a 2.4 GHz band and/or 5 GHz band, etc. The antenna 10 outputs the received signal to the RF section 11. The antenna 10 transmits the signal from the RF section 11 by radio.

The RF section 11 downconverts the received signal from the antenna 10 to that in a suitable frequency band, and outputs the converted signal to the analog-to-digital converter 13. The RF section 11 upconverts the analog baseband signal from the digital-to-analog converter 13 to that in a predetermined frequency band (for example, a 2.4 GHz band and/or 5 GHz band, etc.), and outputs the converted signal to the RF section 11.

The analog-to-digital converter 13 converts the received signal from the RF section 11 into digital signal, and outputs the converted signal to the demodulator 17.

The digital-to-analog converter 12 converts the digital signal from the modulator 16 into analog signals, generates the baseband signal, and outputs the baseband signal to the RF section 11.

The demodulator 17 performs the processing required for the reception on the digital signal from the analog-to-digital converter 13. This processing for the reception includes predetermined demodulation processing, which includes orthogonal frequency division multiplexing (OFDM) recovery, and decoding based on IEEE 802.11. The demodulator 17 uses the processing for the reception to convert a digital signal into a MAC frame, and outputs the MAC frame to the frame processor 18.

The modulator 16 performs the processing required for transmission on the MAC frame from the frame processor 18. This processing for the transmission includes predetermined modulation processing (OFDM modulation) based on IEEE 802.11, and coding. The modulator 16 outputs the digital signal obtained by the processing for transmission to the digital-to-analog converter 12.

The frame processor 18 generates MAC frames (for example, a data frame, and a control frame such as ACK frame, RTS frame, and CTS frame), and outputs them to the modulator 16. The frame processor 18 generates and transmits a control frame to set up an exclusive communication period for each communication scheme which the terminal 3 accommodated by the access point 2 supports.

The schedule manager 19 manages the schedule upon setup of an exclusive communication period for each communication scheme. More specifically, it takes into consideration the number of wireless terminals which support communication schemes accommodated by the access point 2 and a predicted data transmission speed required for the wireless terminals for each communication scheme to determine the duration of the exclusive communication period and the order of exclusive communication periods, etc. Communication schemes refer to, for example, 802.11b, 802.11g, 802.11n, etc. The predicted data transmission speed can be acquired by notification of the data transmission speed from each wireless terminal, or can be predicted by the access point 2 which calculates a theoretical throughput value from the maximum transmission physical rate supported by wireless terminals.

The channel controller 15 generates a control frame based on the schedule managed by the schedule manager 19 in order to set up an exclusive communication period, and orders the frame processor 18 to transmit the generated control frame. More specifically, the channel controller 15 includes the first to third controllers 20-22.

The first controller 20 generates a control frame for forbidding communication by all the terminals 3 accommodated by the access point 2 (for example, the CTS frame), and orders the frame processor 18 to transmit the control frame. That is, the first controller 20 sets up a network allocation vector (NAV) for all the terminals 3.

The second controller 21 generates a control frame for granting communication by the communication scheme for which an exclusive communication period is to be set up (for example, the CF-End frame), and orders the frame processor 18 to transmit the control frame. That is, the second controller 21 lifts the NAV set up for either of the terminals 3.

The third controller 22 generates a control frame for forbidding communication by a communication scheme higher than the communication scheme for which an exclusive communication period is to be set up (for example, a CTS frame), and orders the frame processor 18 to transmit the control frame. That is, the third controller 22 sets up the NAV for either of the terminals 3.

Note that each component of the access point 2 can be realized by analog or digital circuits, or can be realized by software, etc. executed by a CPU.

### <Illustrative Configuration of MAC Frame>

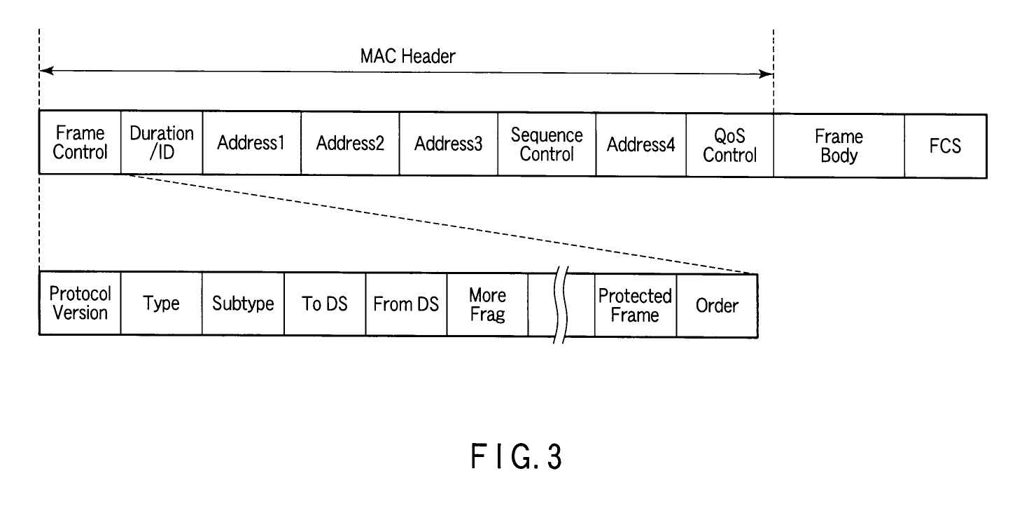

The illustrative configuration of the MAC frame transmitted and received in the wireless LAN system 1 will be described with reference to FIG. 3. FIG. 3 shows the concept of the configuration of the MAC frame.

As shown, the MAC frame basically includes a MAC header part, frame body part, and frame check sequence (FCS) part. The MAC header part carries information required for reception processing in the MAC layer. The frame body part carries information according to the frame type (data from the upper layer, etc.). The FCS part carries a cyclic redundancy code (CRC) used in order to determine whether the MAC header and the frame body were normally received.

The MAC header part includes a Frame Control field, Duration/ID field, at least one Address field (FIG. 3 shows four, i.e. addresses1-address4 as the Address field), and a sequence control field.

The Frame Control field carries a value corresponding to the type of frame. The Duration/ID field carries the duration for which the transmission is suspended (NAV). The Address field carries the direct and/or final address of the data, or the MAC address of the sender. The sequence control field carries the sequence number of the transmitted data and/or the fragment number of the fragmented data.

The Frame Control field includes the protocol version field, Type field, Subtype field, To DS field, From DS field, More Fragment field, Protected Frame field, and Order field, etc.

The Type field and Subtype field carry the information which shows the frame type. The transmitting station can determine which one of the control frame, management frame, and data frame a frame behaves as by the bit string carried in the Type field. The bit string in the Subtype field indicates the MAC frame type in each frame type. The To DS field carries the information which shows whether a receiving station is an access point or a terminal. The From DS field carries the information which shows whether a transmitting station is an access point or a terminal. The More Fragment field carries the information which shows whether a fragmented frame follows or not. The Protected Frame field carries the information which shows whether this frame is protected. The Order field shows that an order of frames must not be shuffled when the frames are relayed.

When a frame is a QoS data frame, the QoS Control field is added to the MAC header. When a frame is a Non-QoS data frame, the QoS Control field is not added. It can be determined whether a frame is a QoS data frame or Non-QoS data frame by determining that the frame is a data frame by the Type field and identifying the bit string in the Subtype field. The QoS Control field includes the TID field (16 kinds; of 0 to 15, are possible) which carries the identifier according to the data traffic, and the Ack Policy field which carries the identification for the reception-confirmation system, etc. Identifying the TID field allows the traffic type of data to be recognized. Identifying the Ack Policy field can determine which one of Normal Ack policy, Block Ack policy, and No Ack policy the QoS data frame has been transmitted by.

### <Operation of Access Point 2>

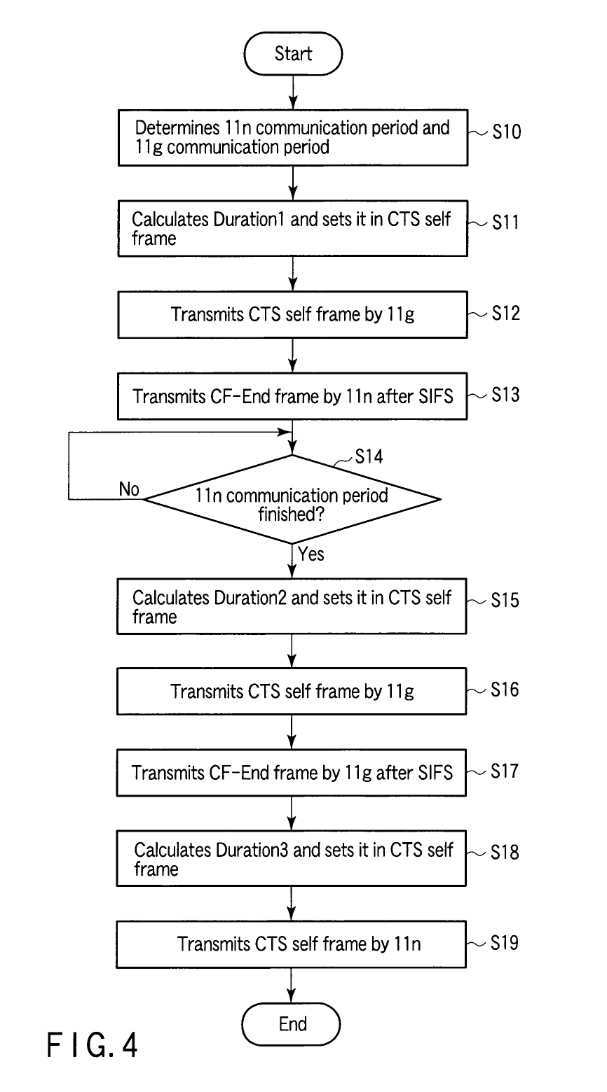

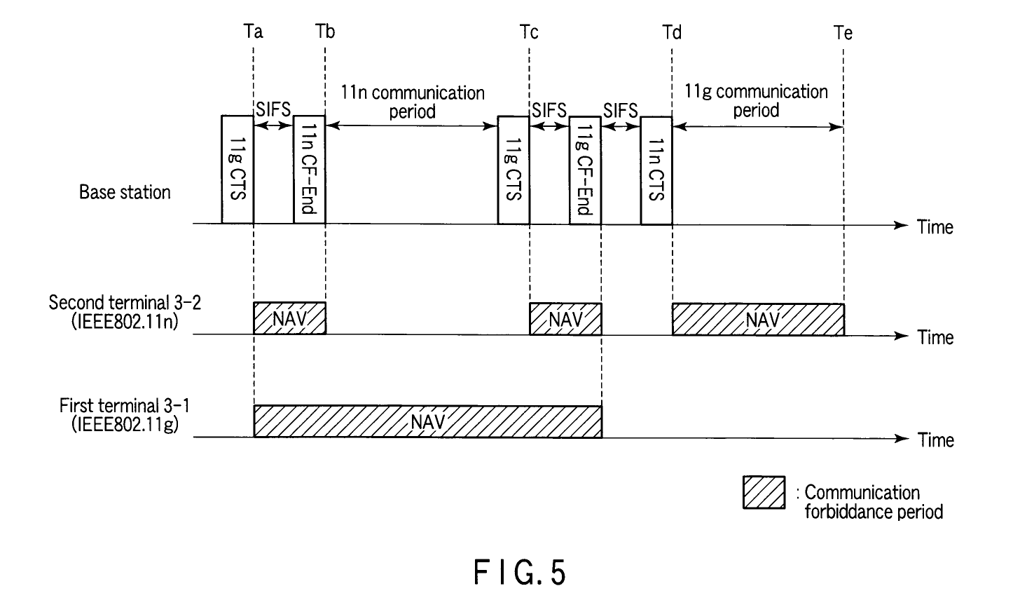

Operation of the access point 2 for setting up an exclusive communication period for each communication scheme which the terminal 3 supports will be described with reference to FIGS. 4 and 5. FIG. 4 shows a flowchart of the operation of the access point 2. FIG. 5 shows a timing chart for the flow of the operation of the access point 2 and the terminal 3. A description will now be given of the frame transmission procedure for setting up a period in which only the second terminal 3-2 which supports the 802.11n can communicate (hereinafter referred to as an 11n communication period) and the period in which only the first terminal 3-1 which supports the 802.11g can communicate (hereinafter referred to as an 11g communication period) in this order by access point 2.

First, the schedule manager 19 in the access point 2 determines the duration of the 11n communication period and 11g communication period, and outputs the determined duration to the channel controller 15 (step S10).

(Setup of 11n communication period)

Then, the access point 2 sets up the 11n communication period. The channel controller 15 calculates Duration1. Then, the channel controller 15 generates a CTS (CTS-self) frame, and sets the calculated Duration1 in the Duration field of the CTS frame (step S11). Then, the channel controller 15 orders the frame processor 18 to transmit the CTS frame generated at step S11 at the rate according to 802.11g. This process is performed by the first controller 20 of the channel controller 15.

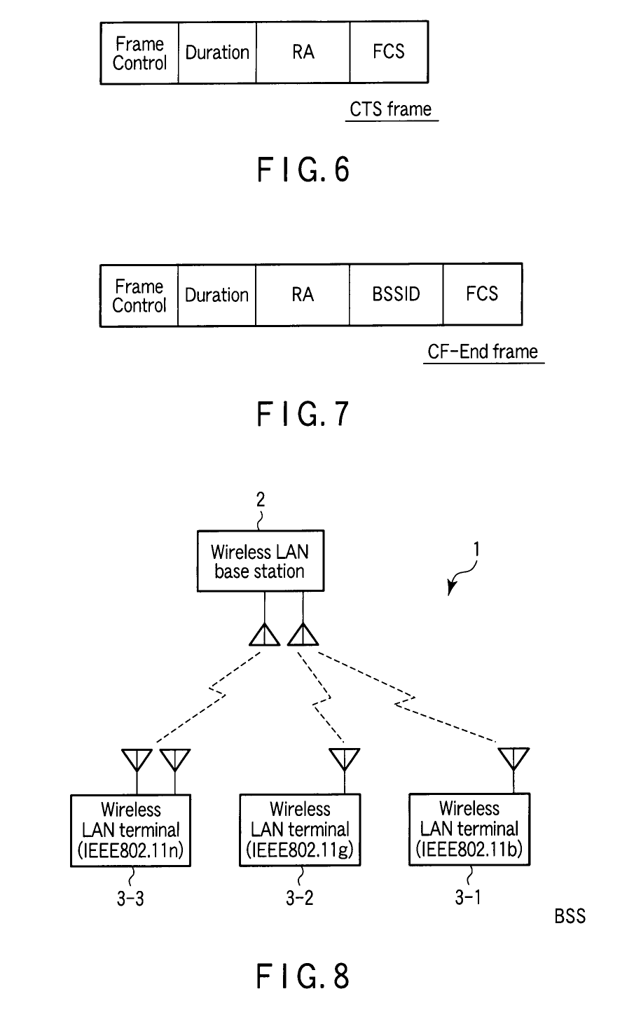

The configuration of the CTS frame will be described with reference to FIG. 6. FIG. 6 schematically shows the format of a CTS frame.

As shown, the CTS frame includes the Frame Control field, Duration field, RA field, and FCS field. The Frame Control field and FCS field are as described above with reference to FIG. 3. It can be identified that this frame is a CTS frame by the control type indicated by the Type field and the CTS subtype indicated by the Subtype field in the Frame Control field. The MAC address of the access point 2 is set in the RA field. In the Duration field, the duration for which transmission by the terminal 3 is to be forbidden is set.

In this example, the transmission of the terminal 3-1 is forbidden until the time Tc in FIG. 5. The time Tc is the end of a period required to transmit the CTS frame after the elapse of the 11n communication period. Therefore, Duration1 is calculated by the following formula.

$$\begin{matrix}Duration 1 = Tc - Ta \\ = ( \begin{matrix}\begin{matrix}SIFS + 11 n CF \text{-} End transmission time + \\ 11 n communication period +\end{matrix} \\ 11 g CTS transmission time\end{matrix} )\end{matrix}$$

The 11n CF-End transmission time in this formula refers to the time required for the transmission of the CF-End frame at the rate according to 802.11n. The 11g CTS transmission time refers to the time required for the transmission of the CTS frame in the rate according to 802.11g. The transmission of these frames will be described later. Short Inter-Frame Space (SIFS) refers to the transmission prohibition period between frames specified by the 802.11n standard. That is, for the transmission of successive frames, the minimum period for which transmission must stop is specified between the transmission of two successive frames. This is SIFS.

More specifically, SIFS is 10 μsec for the communication of a 2.4 GHz band, and is 16 μsec for the communication of a 5 GHz band. In the following description, 10 μsec is used as an example. Since the CF-End frame is 20 bytes in length, the 11n CF-End transmission time is 70 μsec for the transmission by 6.5 Mbps as the rate specified by 802.11n. Since the CTS frame is 14 bytes in length, the 11g CTS transmission time is 50 μsec for the transmission by 6 Mbps as the rate specified by 802.11g. The 11n communication period is determined by the schedule manager 19 in consideration of the number of the second terminals 3-2 (terminal which supports the 802.11n) accommodated by the access point 2 (for example, 5 msec). For the above example, Duration1=5.13 msec.

The frame processor 18 responds to the command from the first controller 20 to transmit the CTS frame generated at step S11 at the rate specified by 802.11g (step S12, time Ta in FIG. 5).

Both the terminals 3-1 and 3-2 can demodulate the frame transmitted at the rate specified by 802.11g. Then, when the MAC address in the RA field of the received frame differs from their own MAC addresses, the 802.11 wireless LAN standard requires the terminals to suspend the transmission for the time shown in the Duration field. Therefore, as shown in FIG. 5, both terminals 3-1 and 3-2 which has received the CTS frame at time Ta suspend the transmission. That is, the NAV is set up to terminals 3-1 and 3-2.

Then, in the access point 2, the second controller 21 of the channel controller 15 generates the CF-End frame, and orders the frame processor 18 to transmit it. Responding to this command, the frame processor 18 transmits the CF-End frame after the elapse of the SIFS period from the time Ta at the rate specified by 802.11n (step S13, time Tb).

Now, The configuration of a CF-End frame will be described with reference to FIG. 7. FIG. 7 schematically shows the format of the CF-End frame.

The CF-End frame includes the CTS frame described with reference to FIG. 6, and the BSSID field added to it. It can be identified that this frame is a CF-End frame by the control type indicated by the Type field and the CF-End subtype indicated by the Subtype field in the Frame Control field. In the RA field, the broadcast address is set. The MAC address of the access point 2 is set in the BSSID field. In the Duration field, “0” is set.

The 802.11 wireless LAN standard requires terminals to lift the NAV when they receive the CF-End frame. Therefore, when the terminal which has suspended transmission by the setup of the NAV receives the CF-End frame, it shifts to the communication enabled state.

As described above, the CF-End frame is transmitted by the communication scheme according to the 802.11n standard. Then, since the second terminal 3-2 is based on the 802.11n standard, it can demodulate this CF-End frame. Therefore, the second terminal 3-2 lifts the NAV (time Tb). On the other hand, since the first terminal 3-1 is based on the 802.11g standard, it cannot demodulate this CF-End frame. Therefore, the first terminal 3-1 does not lift the NAV and maintains communication suspension. As a result, only the second terminal 3-2 based on 802.11n can communicate from time Tb.

The access point 2 sets up a timer over the same period as the 11n communication period at the time Tb to check whether the 11n communication period finishes (step S14). This check may be performed by the schedule manager 19.

### (Setup of 11g Communication Period)

When it is determined that the 11n communication period finishes at step S14 (step S14, YES), the access point 2 sets up the 11g communication period.

Specifically, the first controller 20 of the channel controller 15 first calculates Duration2, and sets it in the Duration field of the CTS (CTS-self) frame (step S15). Then, the channel controller 15 orders the frame processor 18 to transmit the CTS frame generated at step S15 at the rate according to 802.11g.

In this example, the transmission of the terminals 3-1 and 3-3 is forbidden for the period from the time Tc in FIG. 5 to time Te at which the 11g communication period finishes. Therefore, Duration2 is calculated by the following formula.

$$\begin{matrix}Duration 2 = Te - Tc \\ = ( \begin{matrix}\begin{matrix}SIFS + 11 g CF \text{-} End transmission time + \\ SIFS + 11 n CTS transmission time +\end{matrix} \\ 11 g communication period\end{matrix} )\end{matrix}$$

The 11g CF-End transmission time in this formula refers to the time required for the transmission of the CF-End frame at the rate according to 802.11g. The 11n CTS transmission time is the time required for the transmission of the CTS frame at the rate according to 802.11n.

SIFS is 10 μsec as described above. Since the CF-End frame is 20 bytes in length, the 11g CF-End transmission time is 58 μsec for the transmission by 6 Mbps as the rate specified by 802.11g. Since the CTS frame is 14 bytes in length, the 11n CTS transmission time is 66 μsec for the transmission by 6.5 Mbps as the rate specified by 802.11n. The 11g communication period is determined by the schedule manager 19 in consideration of the number of the terminals 3-1 (terminals which support 802.11g) accommodated by the access point 2 (for example, 5 msec). For the above example, Duration2=5.144 msec.

The frame processor 18 responds to the command from the first controller 20 to transmit the CTS frame generated at step S15 at the rate specified by 802.11g (step S16, time Tc).

Both the terminals 3-1 and 3-2 can demodulate a frame transmitted at the rate specified by 802.11g. Therefore, as shown in FIG. 5, the terminals 3-1 and 3-2 which have received the CTS frame set up the NAV at the time Tc, and suspend the communication.

Then, in the access point 2, the second controller 21 of the channel controller 15 generates the CF-End frame and orders the frame processor 18 to transmit it at the rate specified by 802.11g. Responding to this command, the frame processor 18 transmits the CF-End frame at the rate specified by 802.11g after the elapse of the SIFS period from the time Tc (step S17). As a result, the terminals 3-1 and 3-2 which have received the CF-End frame lift the NAV.

The third controller 22 of the channel controller 15 in the access point 2 calculates Duration3, and sets it in the Duration field of the CTS (CTS-self) frame (step S18). Then, the third controller 22 orders the frame processor 18 to transmit the CTS frame generated at step S18 at the rate according to 802.11n.

Duration3 is equivalent to the 11g communication period. Therefore, in this example, Duration3 is calculated by the following formula.

Duration3=Te−Td

The frame processor 18 responds to the command of the third controller 22 to transmit the CTS frame generated at step S18 at the rate specified by 802.11n (step S19, time Td).

The second terminal 3-2 based on 802.11n can demodulate the CTS frame transmitted at the rate according to 802.11n at the time Td. Therefore, the second terminal 3-2 sets up the NAV and suspends the communication. On the other hand, the first terminal 3-1 cannot demodulate the CTS frame transmitted at the rate according to 802.11n. Therefore, the first terminal 3-1 does not set up the NAV. As a result, only the first terminal 3-1 based on 802.11g can communicate from the time Td.

### <Advantage>

As described above, according to the wireless communication device and wireless communication method of the first embodiment of the present invention, a simple technique can secure the individual communication period for several communication schemes. This advantage will be described in detail below.

One radio communication system which allows for the communication by several wireless communication devices with the same medium shared is the IEEE 802.11 standard. In the wireless LAN system of the IEEE 802.11 standard, the communication is performed using the 2.4 GHz band and its maximum data transfer rate is 2 Mbps. The protocol in the physical layer has been mainly changed to improve the data transmission speed. Currently, the wireless LAN standard of IEEE 802.11g has been established for the 2.4 GHz band since 2003, and the wireless LAN standard of IEEE 802.11a has been established for the 5 GHz band since 1999. The maximum data transfer rates of both of these standards are 54 Mbps. Therefore, research on the MAC layer and physical layer of IEEE 802.11n are progressing for realization of a further increased data transmission rate (the maximum of 600 Mbps). Note that “IEEE” in the description of “IEEE 802.11” may be omitted in the following description.

The currently commercially-available wireless LAN devices are based on one or more of the 802.11b, 802.11g, and the 802.11a standards. And, in advance of the 802.11n standardization, products which support 802.11n draft 2.0 are on the market. Under such a situation, wireless communication devices which support different wireless LAN standards may perform wireless communication in the same frequency band.

The wireless LAN system of the 802.11 standard requires that a new standard (for example, 802.11n) should have backward compatibility with the communication scheme of the existing standard (for example, 802.11a, b, or g), when the new standard and the existing standard use the same frequency band. For example, when the wireless communication device which supports 802.11n communicates in the 2.4 GHz band, it can also communicate with the wireless communication device in accordance with the 802.11b and g standards. However, the wireless communication device of the 802.11b and g standards cannot demodulate the radio signal modulated by the wireless communication scheme newly specified by 802.11n. In such a case, the wireless communication devices of the 802.11b and g standards may transmit a frame in the period in which a 802.11n wireless communication device transmits a frame by a new communication scheme. The transmitted frames collide, which reduces the throughput. Therefore, a system for avoiding such a problem and allowing the coexistence needs to be examined.

The IEEE 802.11-2007 standard described in the Related Art section specifies the system which allows for the coexistence of the wireless LAN systems of, for example, the 802.11b and 802.11g standards as a method which enables the coexistence of different wireless LAN standards in the same frequency band. In this system, before the wireless communication device based on the 802.11g standard transmits the OFDM-modulated frame which is specified by the 802.11g standard, it transmits the DSSS-modulated CTS frame which the wireless communication device based on the 802.11b standard can receive. This sets the NAV for all the wireless communication devices, which also includes 802.11b wireless communication devices, to avoid the collision of frames.

However, the method specified by IEEE 802.11-2007 requires, in order that the wireless communication device which supports a new standard may transmit a data frame, the device to transmit the CTS frame which is modulated by the communication scheme which all the wireless communication devices can receive before transmission of the data frame. That is, the CTS frame needs to be transmitted for every transmission of a data frame. This is inefficient.

In the method described by Jpn. Pat. Appln. KOKAI Publication No. 2005-341532, a radio device transmits a beacon or the CTS frame by the communication scheme based on the existing standard, and then starts a frame sequence which enables high-speed transmission, in order to occupy a radio medium.

However, the method described by Jpn. Pat. Appln. KOKAI Publication No. 2005-341532 requires the CTS frame to include the identifier for indicating that it is a period during which a specific sequence is performed. Namely, this technique, in addition to the CTS frame reception processing in the existing standard, requires the interpretation of the identifier by a receiving device, which is a different operation from the conventional CTS frame reception. Therefore, the application of the regulation to commercially-available wireless communication devices requires changes. This is not desirable.

The method described in Jpn. Pat. Appln. KOKAI Publication No. 2006-014258 provides an exclusive period in which only the wireless communication device which supports a new communication scheme can communicate. However, after the exclusive period expires, both a wireless communication device which supports a new communication scheme and another wireless communication device which supports an existing standard can communicate. However, since the opportunity for the transmission is also given to the wireless communication device which supports a new communication scheme in such coexistence environment, the communication period for the wireless communication device which supports only the existing standard may not be fully secured.

In addition to shortcomings described above, the two techniques do not take into consideration the case where three or more communication schemes exist simultaneously.

In contrast with this, the wireless communication device and wireless communication method of this embodiment can solve the problem described above, and can share communication periods fairly among more than one communication schemes. That is, the access point 2 first uses the physical layer protocol which all the terminals 3 can demodulate to transmit the CTS frame (for example, the 11g CTS frame at the time Tc of FIG. 5) to suspend the transmission of all the accommodated wireless terminals.

Then, the access point 2 uses the highest physical layer protocol supported by a terminal for which an exclusive communication period is to be set up to transmit the CF-End frame (the 11g CF-End frame in FIG. 5). Upon the transmission, the suspension of the terminals 3-1 and 3-2 which support a higher communication scheme which includes the physical layer protocol used for the CF-End frame transmission is lifted, and a terminal which supports a lower communication scheme (no corresponding terminal in FIG. 5) maintains the suspension of the transmission.

Then, the access point 2 uses the physical layer protocol one class higher than the physical layer protocol used for the CF-End frame transmission to transmit the CTS frame (the 11n CTS frame at the time Td of FIG. 5). This allows for the communication only by the first terminal 3-1 which supports the physical layer protocol used for the CF-End frame transmission as the supported highest physical layer protocol.

This technique requires no additional changes because the wireless LAN devices on the market can interpret the frames (the CTS frame and CF-End frame) transmitted for the coexistence system. This technique can also divide clearly the period in which the terminal which supports 802.11n can communicate, and the period in which the terminal which supports 802.11g can communicate. It can also prevent reduced communication opportunities for the terminal which supports the 802.11g.

### Second Embodiment

The wireless communication device and wireless communication method according to the second embodiment of the present invention will be described. This embodiment relates to the wireless LAN system in which three communication schemes exist in the same BSS described in the first embodiment.

### <Configuration of Wireless LAN System>

FIG. 8 shows the concept of the BSS according to this embodiment. As shown, the access point 2 constitutes the BSS with the terminals 3-1 to 3-3. In the following description, the terminals 3-1 to 3-3 may be referred to as first to third terminals 3-1 to 3-3, respectively. The configuration of the access point 2 is as described for the first embodiment.

Both the access point 2 and third terminal 3-3 support the communication scheme specified by the IEEE 802.11n. The second terminal 3-2 supports the communication scheme specified by IEEE 802.11g. The first terminal 3-1 supports the communication scheme specified by IEEE 802.11b. That is, the access point 2 and the third terminal 3-3 can transmit and receive not only the radio signal according to the communication scheme specified by IEEE 802.11n but the radio signal according to the communication scheme specified by IEEE 802.11g and IEEE 802.11b. The second terminal 3-2 can transmit and receive not only the radio signal according to the communication scheme specified by IEEE 802.11g but also the radio signal according to the communication scheme specified by IEEE 802.11b.

### <Operation of Access Point 2>

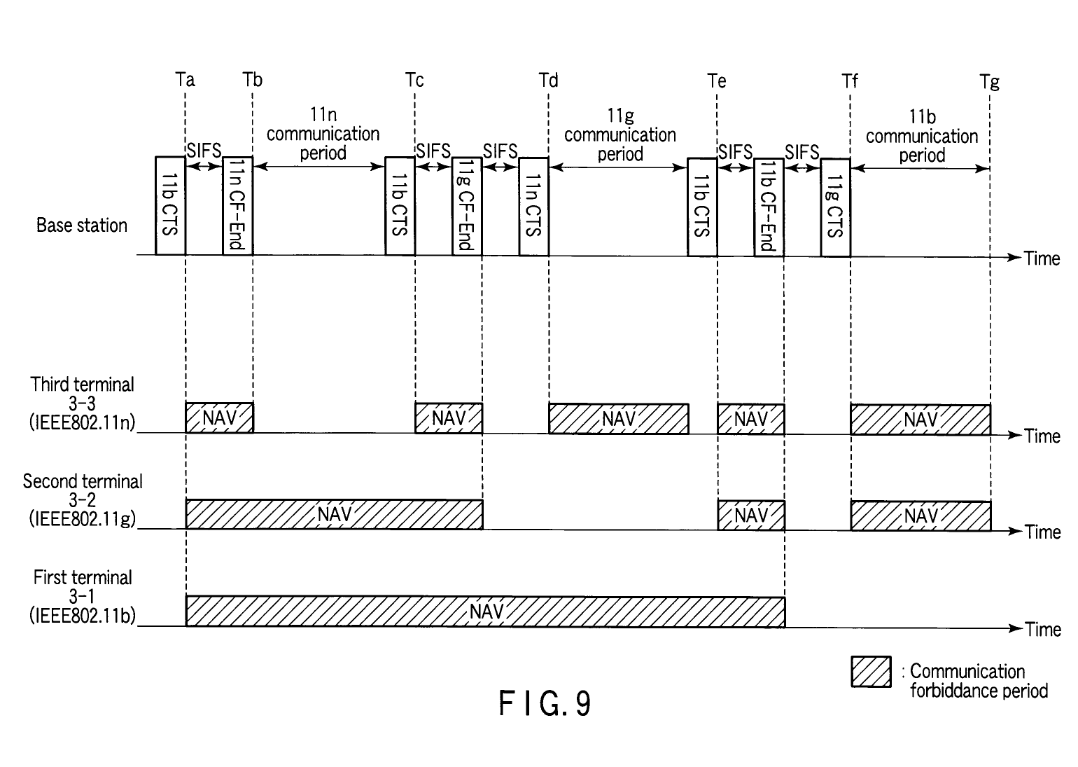

Operation of the access point 2 for setting up an exclusive communication period for all communication schemes which the terminal 3 supports will be described with reference to FIG. 9. FIG. 9 is a timing chart showing the flow of the operation by the access point 2 and the terminal 3. The description will be given of the frame transmission procedure executed by the access point 2 for setting up the period in which only the third terminal 3-3 which supports 802.11n can communicate (11n communication period), the period in which only the second terminal 3-2 which supports 802.11g can communicate (11g communication period), and the period in which only the first terminal 3-1 which supports 802.11b can communicate (hereinafter referred to as an 11b communication period) in the mentioned order.

First, in the access point 2, the schedule manager 19 determines each duration of the 11n communication period, 11g communication period, and 11b communication period, and outputs them to the channel controller 15.

(Setup of 11n Communication Period) The access point 2 first sets up the 11n communication period. For this purpose, the access point 2 transmits the CTS frame at the rate specified by the 802.11b to suspend the transmission by all the terminals 3 (time Ta in FIG. 9). Duration1 is set by the first controller 20 in the Duration field of this CTS frame.

Duration1 is calculated by the following formula.

$$\begin{matrix}Duration 1 = Tc - Ta \\ = ( \begin{matrix}\begin{matrix}SIFS + 11 n CF \text{-} End transmission time + \\ 11 n communication period +\end{matrix} \\ 11 b CTS transmission time\end{matrix} )\end{matrix}$$

Since the CTS frame is 14 bytes in length, for transmission at 1 Mbps as the rate specified by 802.11b, the 11b CTS transmission time in this formula is 304 μsec.

Then, in order to return only the terminal 3-3 which supports the 802.11n to the communication enabled state, the second controller 21 transmits the CF-End frame at the rate specified by 802.11n (time Tb). As a result, set up is a state where the NAV is set to the first and second terminals 3-1 and 3-2 and is lifted from the third terminal 3-3. That is, the 802.11n exclusive communication period is set up.

### (Setup of 11g Communication Period)

After the termination of the 11n communication period, the access point 2 sets up the 11g communication period. First, in order to suspend the transmission by all the terminals 3 again, the first controller 20 transmits the CTS frame at the rate specified by 802.11b (time Tc). In this CTS frame, Duration2 of the following formula is set.

$$\begin{matrix}Duration 2 = Te - Tc \\ = ( \begin{matrix}\begin{matrix}SIFS + 11 g CF \text{-} End transmission time + \\ SIFS + 11 n CTS transmission time +\end{matrix} \\ 11 g communication period + \\ 11 b CTS transmission time\end{matrix} )\end{matrix}$$

Then, in order to return only the terminal 3-2 which supports the 802.11g to the communication enabled state, the second controller 21 transmits the CF-End frame at the rate specified by the 802.11g. Then, the third controller 22 transmits the CTS frame at the rate specified by the 802.11n (time Td). In this CTS frame, Duration3, which is equivalent to the 11g communication period, is set. As a result, set up is a state where the NAV is set to the first and third terminals 3-1 and 3-3 and is lifted from the second terminal 3-2. That is, an 802.11n exclusive communication period is set up.

### (Setup of 11b Communication Period)

After termination of the 11g communication period, the access point 2 sets up the 11b communication period. First, in order to suspend the transmission by all the terminals 3 again, the first controller 20 transmits the CTS frame at the rate specified by the 802.11b (time Te). In this CTS frame, Duration4 of the following formula is set.

$$\begin{matrix}Duration 4 = Tg - Te \\ = ( \begin{matrix}\begin{matrix}SIFS + 11 b CF \text{-} End transmission time + \\ SIFS + 11 g CTS transmission time +\end{matrix} \\ 11 b communication period\end{matrix} )\end{matrix}$$

Since the CF-End frame is 20 bytes in length, for transmission by 1 Mbps as the rate specified by the 802.11b, the 11b CF-End transmission time in this formula is 352 μsec.

Then, in order to return only the terminal 3-1 which supports 802.11b to the communication enabled state, the second controller 21 transmits the CF-End frame at the rate specified by 802.11b. Then, the third controller 22 transmits the CTS frame at the rate specified by 802.11g (time Tf). In this CTS frame, Duration5, which is equivalent to the 11b communication period, is set. As a result, set up is a state where the NAV is set to the second and third terminals 3-2 and 3-3 and is lifted from the first terminal 3-1. That is, an exclusive communication period according to 802.11b is set up.

### <Advantage>

As described above, even if three communication schemes exist, the second embodiment can set up an exclusive communication period for the terminal of each communication scheme.

### Third Embodiment

The wireless communication device and wireless communication method according to the third embodiment of the present invention will be described. In the first and second embodiments, in order to suspend the transmission of all the terminals 3, the CTS frame is transmitted using the communication scheme supported by all the terminals 3. In contrast, this embodiment uses the beacon frame to omit the transmission of the CTS frame. The third embodiment will be described using as an example the BSS of FIG. 8 illustrated in the description for the second embodiment.

### <Beacon Frame>

First, the beacon frame will be described. The access point 2 transmits the beacon frame at a fixed interval (for example, 100 ms). The access point 2 according to this embodiment puts the duration for which transmission of all the terminals 3 is suspended in the beacon frame.

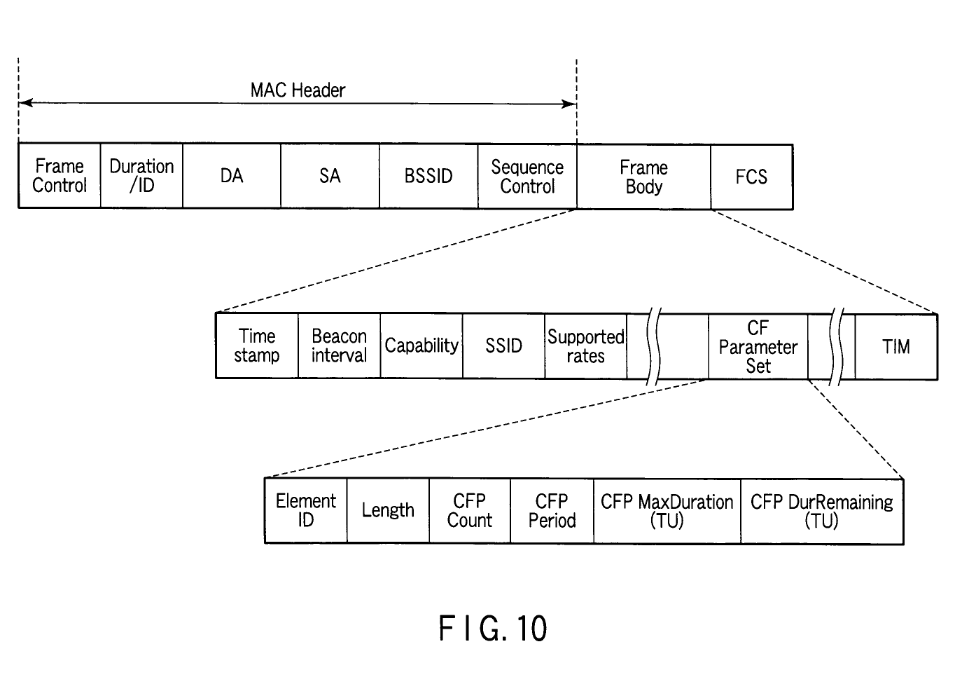

FIG. 10 schematically shows the format of the beacon frame. As shown, the beacon frame includes the MAC header part, frame body part, and FCS section.

The frame body part includes the time stamp field, beacon interval field, capability field, SSID element, supported rates element, CF Parameter Set element, and traffic indication message (TIM) element.

The time stamp field carries the time stamp used for synchronizing the access point 2 and the terminal 3. The beacon interval field carries the transmission interval of beacon frames. The capability field is used for notifying the existence of the function implemented by the access point 2. The SSID element is a network identifier which a user can specify arbitrarily. The supported rates element is information on the rate which the access point 2 supports. The CF Parameter Set element gives the definition of the parameter regarding the Contention Free Period (CFP). The TIM element shows the state of traffic buildup in the access point 2.

The CF Parameter Set element includes several elements. That is, it includes the element ID, length field, CFP Count field, CFP Period field, CFP MaxDuration field, and CFP DurRemaining field.

The element ID is an ID for identifying (“4” being illustrated) the element. The length field shows the length of the element (“6” being illustrated). The CFP count shows the number of Delivery TIMs (DTIM) up to the start of the next CFP. The CFP period shows the number of DTIMs of the CFP interval. CFP MaxDuration shows the period from the start to the end of the CFP (in TU units (1 TU=1024 μsec) defined by the IEEE 802.11 standard). CFP DurRemaining shows the period from the present to the end of CFP.

DTIM refers to the time at which the access point 2 transmits the beacon frame before the broadcast transmission. The wireless terminals in the power save mode must also be ready for the reception at the DTIM. That information on when the DTIM happens is included in the TIM field.

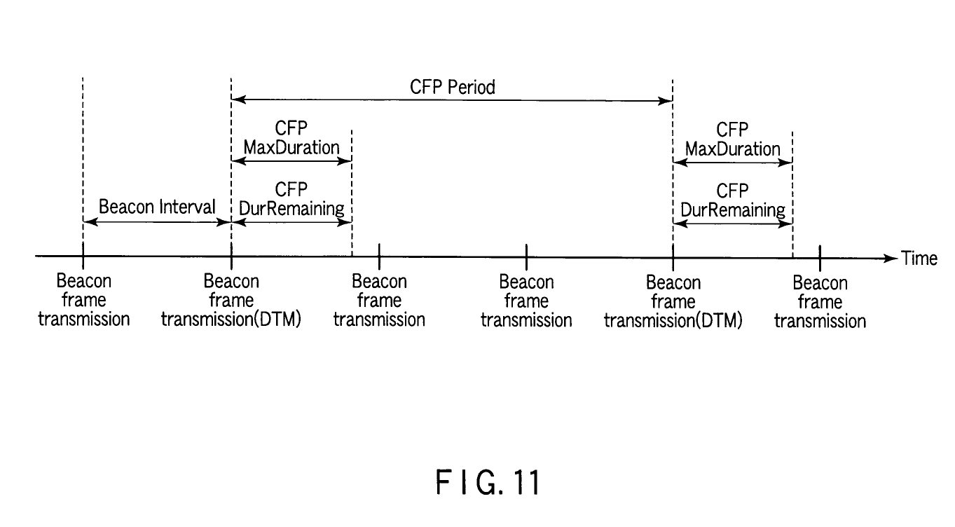

FIG. 11 is a timing chart showing the relation between the CFP periods and the beacon frames. As shown, the beacon frame is transmitted at a fixed cycle. Therefore, the CFP is set up whenever a beacon frame is transmitted three times. Within the period of CFP MaxDuration, the access point 2 determines which terminal 3 in the BSS transmits and receives the signal. Each terminal 3 scrambles for a communication right after CFP MaxDuration elapses.

The setup of an exclusive communication period for each communication scheme by the access point 2 in the period of the CFP MaxDuration will now be described.

### <Operation of Access Point 2>

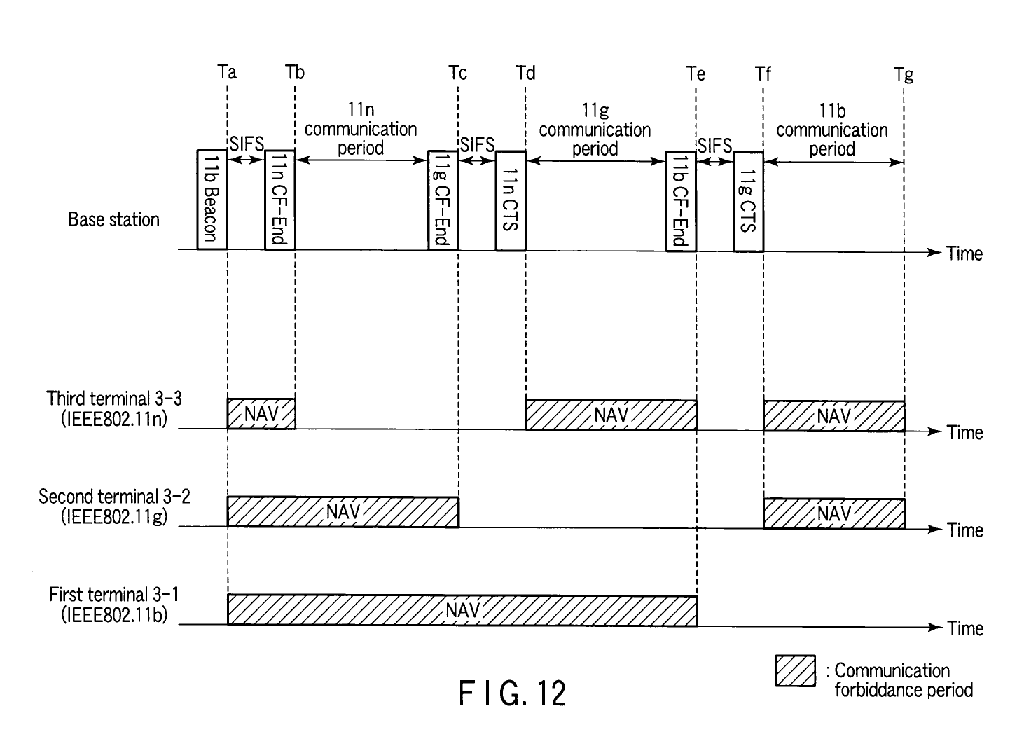

FIG. 12 is a timing chart showing the flow of operation of the access point 2 and terminal 3.

As shown, the frame sequence in this embodiment is the same as that of the sequence with the omission of the transmission of the CTS frame by the rate specified in 802.11b for setting up each of the 11n communication period, 11g communication period, and 11b communication period in FIG. 9 for the second embodiment. The details are as follows.

First, the access point 2 transmits the beacon frame at DTIM, (time Ta). At this time, the access point 2 sets the value of the CFP DurRemaining in the CF Parameter Set element in the beacon frame to the duration of the period in which the transmission of all the terminals 3 is suspended. This value is, for example, the same duration as the period required for the elapse of the total of the 11n communication period, 11g communication period, and 11b communication period. Note that naturally all the terminals 3 can receive a beacon frame. As a result, the NAV is set for all the first to third terminals 3-1 to 3-3 at the time Ta. That is, the same state as the state where the CTS frame was transmitted at the time Ta in the second embodiment can be obtained.

### (Setup of 11n Communication Period)

Then, the access point 2 sets up the 11n communication period. That is, the second controller 21 transmits the CF-End frame at the rate specified by 802.11n (time Tb). Thereby, the first and second terminals 3-1 and 3-2 maintain the NAV, and the third terminal 3-3 lifts the NAV. As a result, an exclusive communication period for 802.11n is set up.

### (Setup of 11g Communication Period)

After the elapse of the 11n communication period, the access point 2 sets up the 11g communication period. At this time, the first and second terminals 3-1 and 3-2 maintain the NAV.

Therefore, the access point 2 transmits the CF-End frame at the rate specified by 802.11g, without transmitting the CTS frame at the rate specified by 802.11b. This lifts the NAV from the second terminal 3-2 (time Tc).

Then, the third controller 22 transmits the CTS frame at the rate specified by 802.11n (time Td). In this CTS frame, Duration3, which is equivalent to the 11g communication period, is set. This is the same as the second embodiment. As a result, the NAV is set to the third terminal 3-3.

As a result, set up is a state where the NAV is set to the first and third terminals 3-1 and 3-3 and is lifted from the second terminal 3-2. That is, an exclusive communication period for 802.11n is set up.

### (Setup of 11b Communication Period)

After the elapse of the 11g communication period, the access point 2 sets up the 11b communication period. At this time, the first terminal 3-1 maintains the NAV. Therefore, the access point 2 transmits the CF-End frame at the rate specified by 802.11b, without transmitting the CTS frame at the rate specified by 802.11b. This lifts the NAV from the first terminal 3-1 (time Te).

Then, the third controller 22 transmits the CTS frame at the rate specified by 802.11g (time Tf). In this CTS frame, Duration5, which is equivalent to the 11b communication period, is set. This is the same as the second embodiment. As a result, the NAV is set to the second and third terminals 3-2 and 3-3.

As a result, set up is a state where the NAV is set to the second and third terminals 3-2 and 3-3 and is lifted from the first terminal 3-1. That is, an exclusive communication period according to 802.11n is set up.

### <Advantage>

The method according to this embodiment can use the beacon frame to set the NAV for the terminal 3. Therefore, when setting up each communication period, there is no necessity of transmitting the CTS frame by the communication scheme supported by all the terminals. Therefore, the configuration of the access point 2 can be simplified (the first controller 20 is unnecessary), and the speed of operation can be accelerated.

### Fourth Embodiment

The wireless communication device and wireless communication method according to the fourth embodiment of this invention will be described next. This embodiment relates to a configuration in which the difference between communication schemes in the second embodiment is replaced by the difference in the frequency bandwidth. Since other configurations and operations are the same as those of the second embodiment, only differences of this embodiment from the second embodiment regarding them will be described.

### <Configuration of Wireless LAN System>

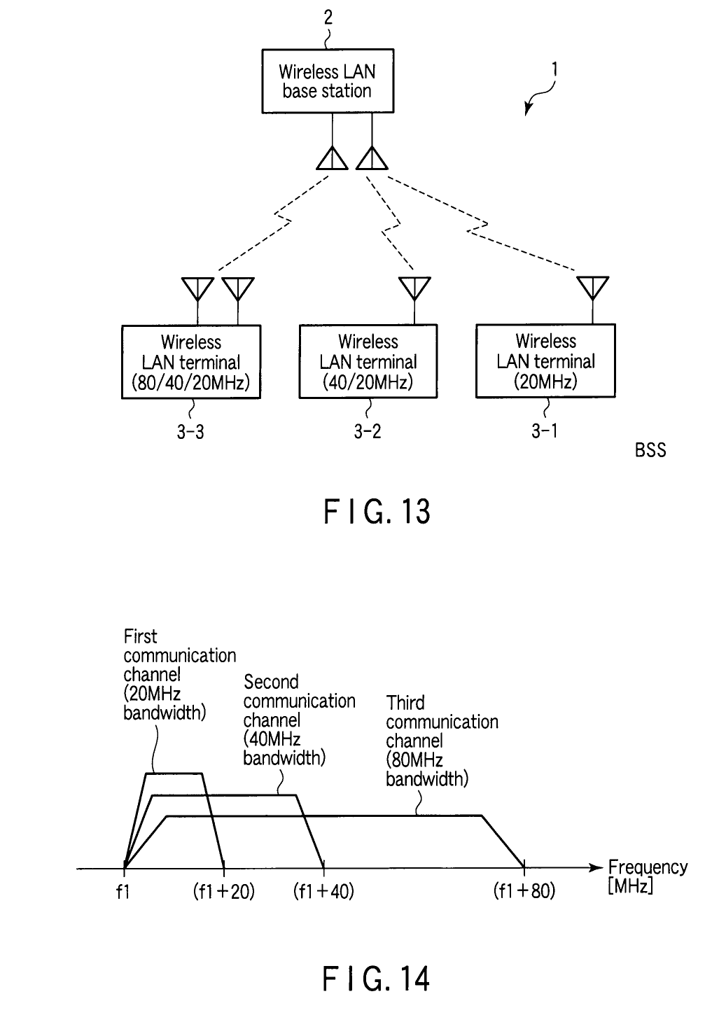

FIG. 13 shows the concept of the BSS according to this embodiment. As shown, the wireless LAN system 1 includes the access point 2 and first to third terminals 3-1 to 3-3. They constitute the BSS.

The access point 2 and the third terminal 3-3 can use the first communication channel which has the bandwidth of 20 MHz, the second communication channel which has the bandwidth of 40 MHz, and the third communication channel which has the bandwidth of 80 MHz to communicate. The second terminal 3-2 can use the first and second communication channels to communicate and cannot use the third communication channel. The first terminal 3-1 can use the first communication channel to communicate and cannot use the second and third communication channels.

FIG. 14 shows the frequency band used for the first to third communication channels. As shown, the first communication channel uses the bandwidth which ranges from the frequency f1 to (f1+20) MHz. The second communication channel uses the bandwidth which ranges from the frequency f1 to (f1+40) MHz. The third communication channel uses the bandwidth which ranges from the frequency f1 to (f1+80) MHz. That is, the second communication channel includes the band used for the first communication channel, and the third communication channel includes the band used for the first and second communication channels.

### <Operation of Access Point 2>

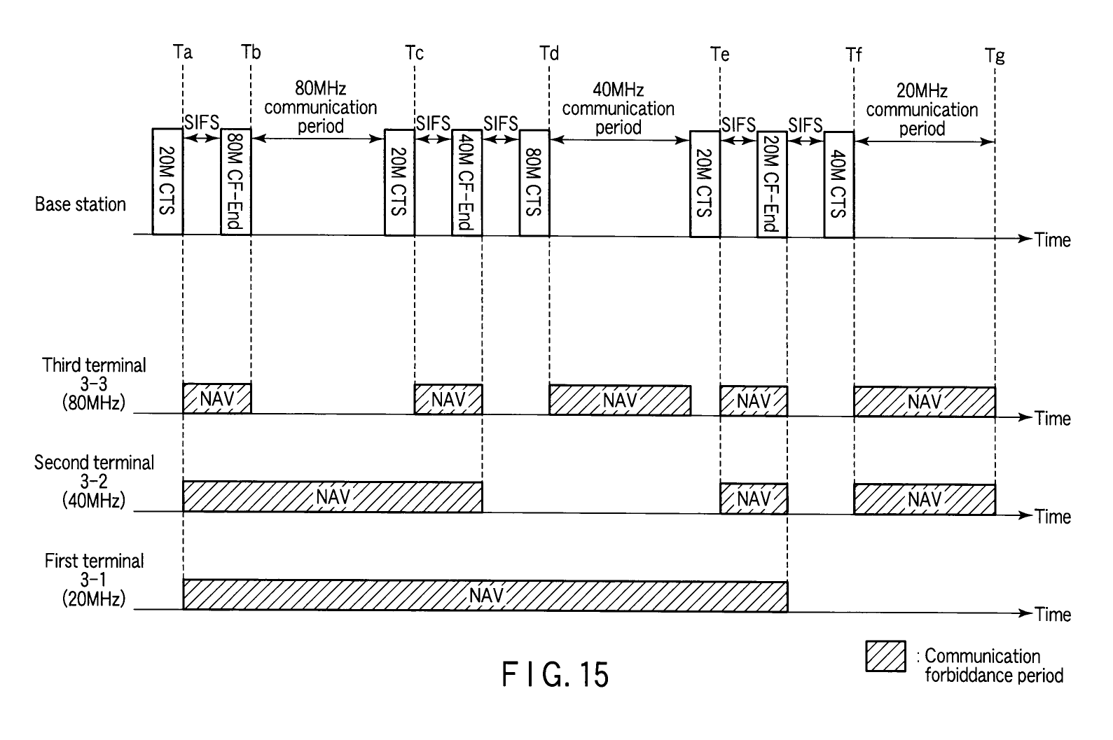

The operation performed by the access point 2 for setting up an exclusive communication period for each communication scheme which the terminals 3 support will be described with reference to FIG. 15. FIG. 15 is a timing chart showing the operational flow of the access point 2 and terminal 3. A description will be given of the frame transmission procedure performed by the access point 2 for setting up the period in which only the third terminal 3-3 which supports first to third communication channels can communicate (hereinafter referred to as an 80 MHz communication period), the period in which only the second terminal 3-2 which supports the first and second communication channels can communicate (hereinafter referred to as a 40 MHz communication period), and the period in which only the first terminal 3-1 which supports only the first communication channel can communicate (hereinafter referred to as a 20 MHz communication period) in the mentioned order.

First, the schedule manager 19 in the access point 2 determines the duration of the 80 MHz communication period, 40 MHz communication period, and 20 MHz communication period, and outputs them to the channel controller 15.

### (Setup of 80 MHz Communication Period)

The access point 2 first sets up the 80 MHz communication period. For this purpose, the access point 2 uses the first communication channel to transmit the CTS frame to suspend the transmission of all the terminals 3 (time Ta in FIG. 15). Duration1 is set by the first controller 20 in the Duration field of this CTS frame. Duration1 is calculated by the following formula.

$$\begin{matrix}Duration 1 = Tc - Ta \\ = ( \begin{matrix}\begin{matrix}SIFS + 80 M CF \text{-} End transmission time + \\ 80 MHz communication period +\end{matrix} \\ 20 M CTS transmission time\end{matrix} )\end{matrix}$$

The 80M CF-End transmission time in this formula is the time required for transmitting the CF-End frame using a third communication channel. The 20M CTS transmission time is the time required for transmitting the CTS frame using the first communication channel.

Therefore, the second controller 21 uses the third communication channel to transmit the CF-End frame to return only the third terminal 3-3 which supports the first to third communication channels to the communication enabled state (time Tb). As a result, set up is a state where the NAV is set to the first and second terminals 3-1 and 3-2 and is lifted from the third terminal 3-3. That is, the 80 MHz exclusive communication period is set up.

### (Setup of 40 MHz Communication Period)

After the end of the 80 MHz communication period, the access point 2 sets up the 40 MHz communication period. First, the first controller 20 uses the first communication channel to transmit the CTS frame to suspend the transmission of all the terminals 3 again (time Tc). Duration2 of the following formula is set in this CTS frame.

$$\begin{matrix}Duration 2 = Tg - Te \\ = ( \begin{matrix}\begin{matrix}SIFS + 40 M CF \text{-} End transmission time + \\ SIFS + 80 M CTS transmission time +\end{matrix} \\ 40 MHz communication period + \\ 20 M CTS transmission time\end{matrix} )\end{matrix}$$

The 40M CF-End transmission time in this formula is the time required for the transmission of the CF-End frame using the second communication channel. The 80M CTS transmission time is the time required for the transmission of the CTS frame using the third communication channel.

Then, the second controller 21 uses the second communication channel to transmit the CF-End frame to return only the second terminal 3-2 which supports the first and second communication channels to the communication enabled state. Then, the third controller 22 uses the third communication channel to transmit the CTS frame (time Td). In this CTS frame, Duration3, which is equivalent to the 40 MHz communication period, is set. As a result, set up is a state where the NAV is set for the first and third terminals 3-1 and 3-3 and is lifted from the second terminal 3-2. That is, a 40 MHz exclusive communication period is set up.

### (Setup of 20 MHz Communication Period)

After the end of the 40 MHz communication period, the access point 2 sets up a 20 MHz communication period. First, the first controller 20 uses the first communication channel to transmit the CTS frame to suspend the transmission of all the terminals 3 again (time Te). Duration4 of the following formula is set in this CTS frame.

$$\begin{matrix}Duration 4 = Tg - Te \\ = ( \begin{matrix}\begin{matrix}SIFS + 20 M CF \text{-} End transmission time + \\ SIFS + 40 M CTS transmission time +\end{matrix} \\ 20 MHz communication period\end{matrix} )\end{matrix}$$

The 20M CF-End transmission time in this formula is the time required for the transmission of the CF-End frame using the first communication channel. The 40M CTS transmission time is the time required for the transmission of the CTS frame using the second communication channel.

Then, the second controller 21 uses the first communication channel to transmit the CF-End frame to return only the terminal 3-1 which supports only the first communication channel to the communication enabled state. Then, the third controller 22 uses the second communication channel to transmit the CTS frame (time Tf). In this CTS frame, Duration5, which is equivalent to the 20 MHz communication period, is set. As a result, set up is a state where the NAV is set to the second and third terminals 3-2 and 3-3 and is lifted from the first terminal 3-1. That is, a 20 MHz exclusive communication period is set up.

### <Advantage>

As described above, the fourth embodiment can set up an exclusive communication period for each terminal in the wireless LAN system including several terminals 3 which use different communication channels. Note that although this embodiment is described using as an example the case where three different communication channels can be used, two different communication channels may be used as in the first embodiment.

This embodiment can also be applied to the third embodiment. In this case, the beacon frame only needs to be transmitted using the first communication channel. This removes the necessity for the transmission of the CTS frame at the time Tc and Te.

### Fifth Embodiment

The wireless communication device and wireless communication method according to the fifth embodiment of the present invention will now be described. This embodiment relates to a configuration where the difference between the communication schemes in the first embodiment is replaced by the difference in the physical frame format. Since other configurations and operations are the same as those of the first embodiment, only differences of this embodiment from the first embodiment will be described.

### <Configuration of Wireless LAN System>

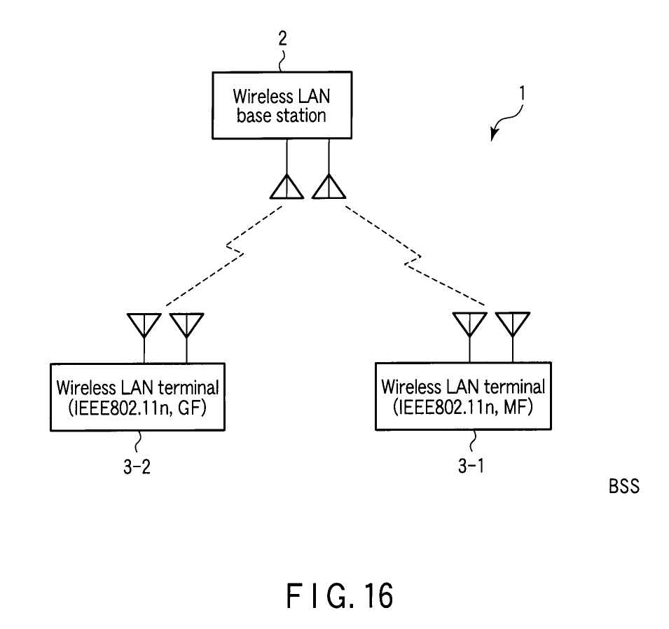

FIG. 16 shows the concept of the BSS according to this embodiment. As shown, the wireless LAN system 1 includes the access point 2, first and second terminals 3-1 and 3-2. They constitute the BSS. Both the access point 2 and terminal 3 are based on IEEE 802.11n.

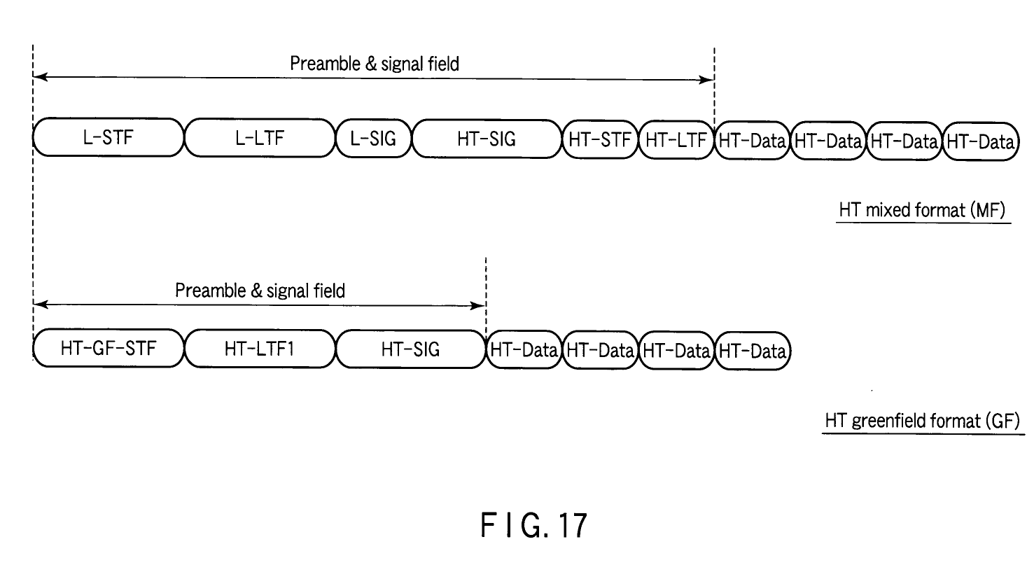

The IEEE 802.11n standard specifies two physical frame formats. One is a format called HT mixed format, which must be implemented (hereinafter referred to as an MF). The other is a format called HT greenfield format, which is optional (hereinafter referred to as a GF). The configuration of these formats is shown in FIG. 17. FIG. 17 schematically illustrates the configuration of the MF and GF.

As shown, the difference between the MF and GF is the configuration of the preamble. A preamble is a known signal, and is a signal used in order to attempt to acquire the synchronization of the data transmitted and received. The preamble of the MF includes a Legacy-Short Training Field (L-STF), Legacy-Long Training Field (L-LTF), Legacy-Signal Field (L-SIG), High Throughput-SIG (HT-SIG), High Throughput-STF (HT-STF), and High Throughput-LTF (HT-LTF).

The L-STF, L-LTF, and L-SIG have the same information as the information used for transmitting and receiving a frame according to the IEEE.802.11a and g standards. On the other hand, the HT-STF, HT-LTF, and HT-SIG are information used for transmitting and receiving the frame according to the IEEE 802.11n standard.

The preamble of the GF includes HT-Greenfield STF (HT-GF-STF), HT-LTF1, and HT-SIG.

The L-STF, HT-STF, and HT-GF-STF are used on the execution of the synchronous acquisition for the reception of the signal, and can mainly be used for frame detection or timing detection. Similarly, L-LTF, HT-LTF, and HT-LTF1 are used on the execution of the synchronous acquisition for reception of the signal, and can mainly be used for carrier frequency error compensation, reference amplitude, phase detection, etc. The L-SIG and HT-SIG carry information on the length of the data included in the data part of a frame, transmission rate, modulation method, etc.

In FIG. 16, the first terminal 3-1 uses the frame of the MF to transmit and receive a signal, and the second terminal 3-2 uses the frame of the GF to transmit and receive a signal. The second terminal 3-2, which can recognize a frame transmitted by the GF, can also recognize a frame transmitted by the MF. However, the first terminal 3-1 cannot recognize a frame transmitted by the GF.

### <Operation of Access Point 2>

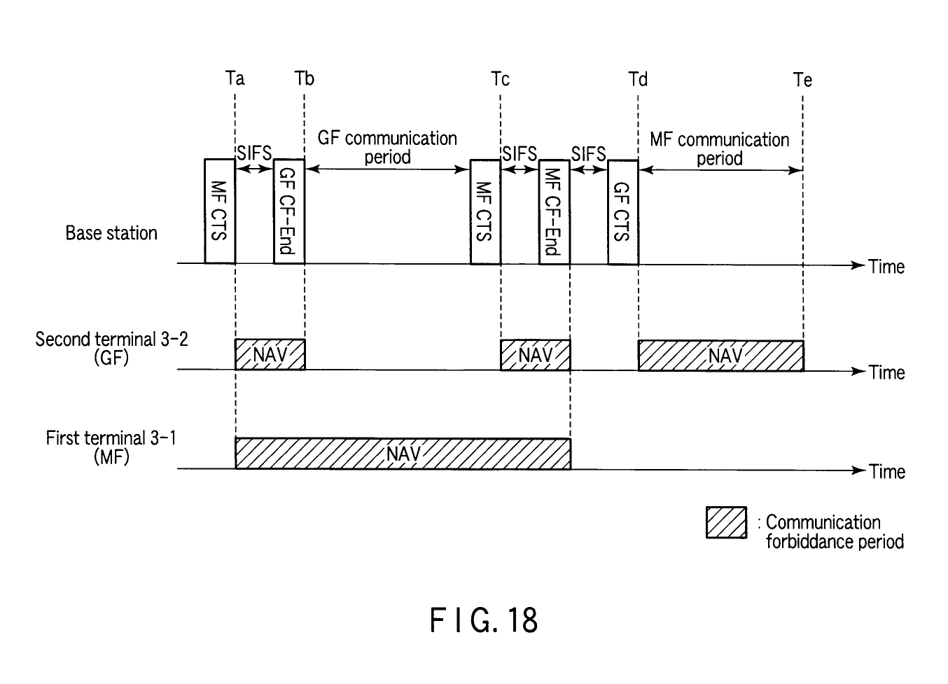

The operation of the access point 2 for setting up an exclusive communication period for all communication schemes supported by the terminals 3 will now be described with reference to FIG. 18. FIG. 18 is a timing chart showing the operational flow of the access point 2 and terminal 3. A description will be given of the frame transmission procedure executed by the access point 2 for setting up the period in which only the second terminal 3-2 which supports the GF can communicate (hereinafter referred to as a GF communication period), and the period in which only the first terminal 3-1 which supports MF can communicate (hereinafter referred to as an MF communication period).

First, the schedule manager 19 in the access point 2 determines the duration of the GF communication period and MF communication period, and outputs them to the channel controller 15.

### (Setup of GF Communication Period)

The access point 2 first sets up the GF communication period. For this purpose, the access point 2 transmits the CTS frame of the MF to suspend the transmission by all the terminals 3 (time Ta in FIG. 15). Duration1 is set by the first controller 20 in the Duration field of this CTS frame.

Duration1 is calculated by the following formula.

$$\begin{matrix}Duration 1 = Tc - Ta \\ = ( \begin{matrix}\begin{matrix}SIFS + GF CF \text{-} End transmission time + \\ GF communication period +\end{matrix} \\ MF CTS transmission time\end{matrix} )\end{matrix}$$

The GF CF-End transmission time in this formula is the time required for the transmission of the CF-End frame of the GF. The MF CTS transmission time is the time required for the transmission of the CTS frame of the MF.

Therefore, the second controller 21 transmits the CF-End frame of the GF to return only the second terminal 3-2 which supports the GF to the communication enabled state (time Tb). As a result, the NAV of the second terminal 3-2 is lifted, and the GF communication period is set up.

### (Setup of MF Communication Period)

After the end of the GF communication period, the access point 2 sets up the MF communication period. For this purpose, the access point 2 transmits the CTS frame of the MF to suspend the transmission by all the terminals 3 again (time Tc). Duration2 of the following formula is set in this CTS frame.

$$\begin{matrix}Duration 2 = Te - Tc \\ = ( \begin{matrix}\begin{matrix}SIFS + MF CF \text{-} End transmission time + \\ SIFS + GF CTS transmission time +\end{matrix} \\ MG communication period +\end{matrix} )\end{matrix}$$

The MF CF-End transmission time in this formula is the time required for the transmission of the CF-End frame of the MF. The GF CTS transmission time is the time required for the transmission of the CTS frame of the GF.

Then, the second controller 21 transmits the CF-End frame of the MF to return only the terminal 3-2 which supports the MF and does not support the GF to the communication enabled state. Then, the third controller 22 transmits the CTS frame of the GF (time Td). In this CTS frame, Duration3, which is equivalent to the GF communication period, is set. As a result, the NAV is set for the first terminal 3-1 and is lifted from the second terminal 3-2. That is, the MF communication period is set up.

### <Advantage>

As described above, the fifth embodiment can set up an exclusive communication period for each terminal in the wireless LAN system including several terminals 3 which use different frame formats. Note that although the this embodiment is described using as an example the case where two different frame formats can be used, three or more different frame formats may be used.

This embodiment can also be applied to the third embodiment. In this case, the beacon frame of the MF only needs to be transmitted. This removes the necessity for the transmission of the CTS frame at the time Tc.

As described above, in the wireless communication device and wireless communication method according to the first to fifth embodiments of the present invention, the opportunity for communication for each communication scheme can be equally secured in a radio communication system which allows for several communication schemes.

Embodiments are described based on the standard which distinguishes different communication schemes used in the first embodiment, the communication channel in the fourth embodiment, and the frame format in the fifth embodiment. However, the present invention can also use other items for differentiation. Also, although three different communication schemes are used as an example to describe the second and fourth embodiments, four or more different communication schemes may be used. The fifth embodiment may use three or more different frame formats. Naturally, the fifth embodiment can also be applied to the configuration of frame formats other than MF and GF.

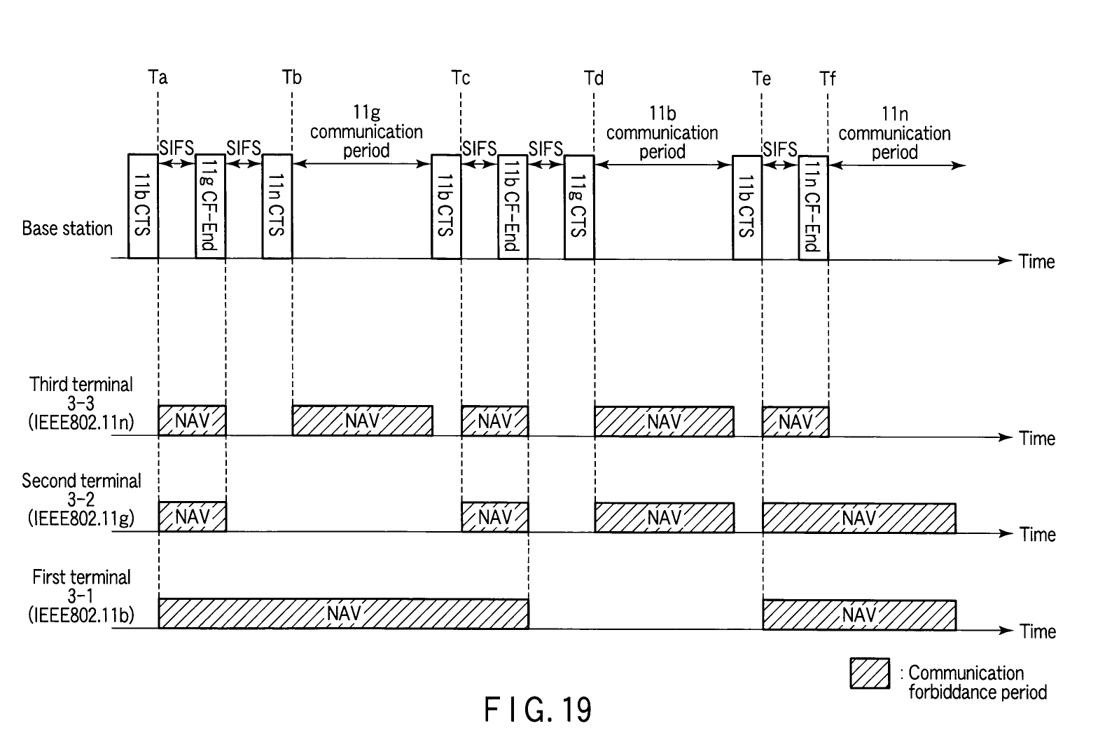

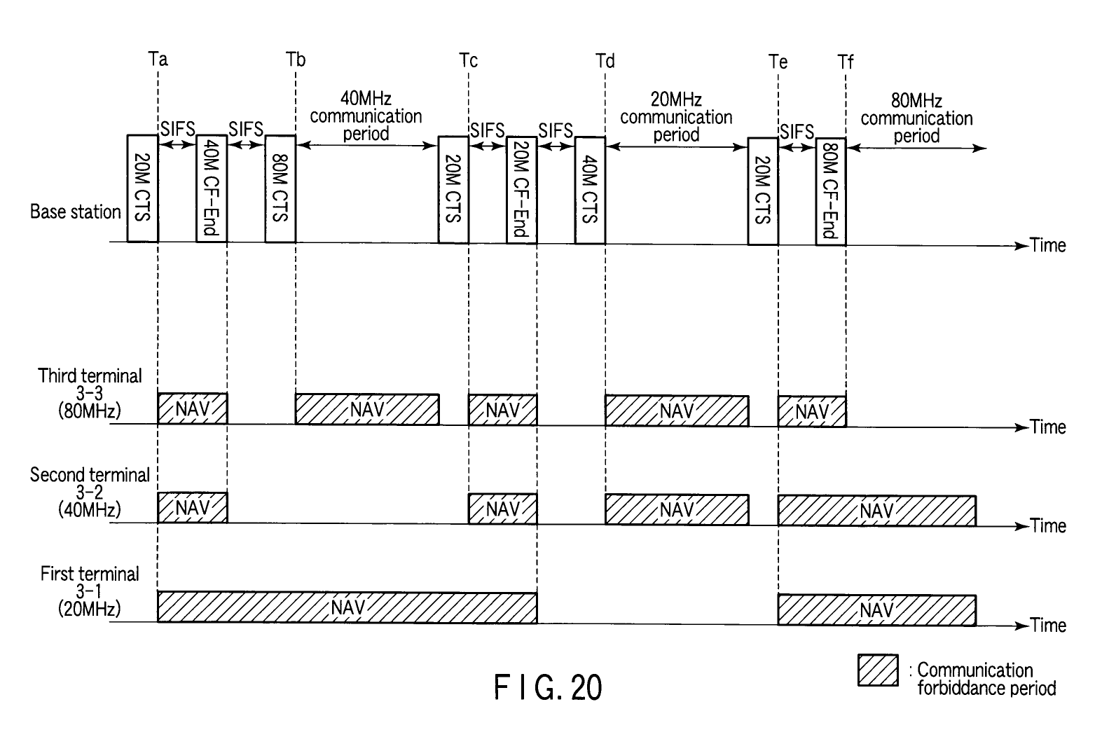

The description for the embodiments is given of the example in which exclusive communication periods are set in the order from the highest communication schemes with backward compatibility. Namely, a description is given of an example in which exclusive communication periods are set up in order of 802.11n and 802.11g in the first embodiment, 802.11n, 802.11g, and 802.11b in the second and third embodiments, 80 MHz, 40 MHz, and 20 MHz in the fourth embodiment, and GF and MF in the fifth embodiment. However, the setup of such from the highest communication scheme is not essential. A setup in any order is possible as long as the transmission order of the CTS frame and CF-End frame is maintained. Such an example is described with reference to FIGS. 19 and 20.

FIG. 19 shows illustrative modified first and second embodiments and the frame sequence for setting up an exclusive communication period for 802.11g, 802.11b, and 802.11n in the mentioned order.

First, in order to set up the 11g communication period, the access point 2 transmits the CTS frame at the rate according to 802.11b to set the NAV for all the terminals 3 (time Ta). Then, the access point 2 transmits the CF-End frame at the rate of 802.11g to lift the NAV from terminals 3-2 and 3-3. Then, the access point 2 transmits the CTS frame at the rate according to 802.11n. As a result, only the second terminal 3-2 can transmit (time Tb).

Then, in order to set up the 11b communication period, the access point 2 transmits the CTS frame at the rate according to 802.11b to set the NAV to all the terminals 3 (time Tc). Then, the access point 2 transmits the CF-End frame at the rate according to 802.11b to lift the NAV from the terminal 3-1 to 3-3. Then, the access point 2 transmits the CTS frame at the rate according to 802.11g. As a result, only the first terminal 3-1 can transmit (time Td).

Finally, in order to set up the 11n communication period, the access point 2 transmits the CTS frame at the rate according to 802.11b to set the NAV for all the terminals 3 (time Te). Then, the access point 2 transmits the CTS frame at the rate according to 802.11n. As a result, only the third terminal 3-3 can transmit (time Tf).

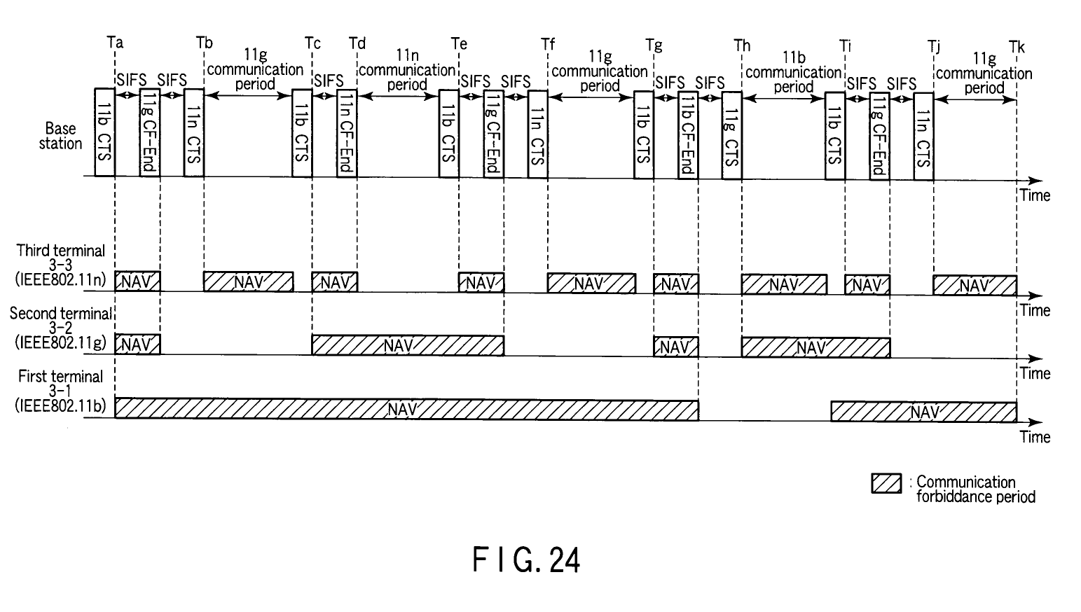

Furthermore, the schedule manager 19 can also grant more opportunities for communication for a specific communication scheme than other communication schemes rather than equally sharing them among all communication schemes. Such assignment of communication opportunity may be applied to a case in which data transmitted by a communication scheme is for voice over IP (VoIP) use, for example. The opportunity for communication needs to be granted for a channel for VoIP with a regular cycle (for example, 20 msec). This example will be described with reference to FIG. 24.

FIG. 24 shows the frame sequence of the second modification example of the second embodiment. FIG. 24 shows an example in which more opportunities for communication are granted to communication by the communication scheme specified by 802.11g than that by the remaining communication schemes specified by 802.11b and 802.11n.

First, in order to set up the 11g communication period, the access point 2 transmits the CTS frame at the rate according to 802.11b to set the NAV to all the terminals 3 (time Ta). Then, the access point 2 transmits the CF-End frame at the rate according to 802.11g to lift the NAV from the terminal 3-2 and 3-3. Then, the access point 2 transmits the CTS frame at the rate according to 802.11n. As a result, only the second terminal 3-2 can transmit (time Tb).

Then, in order to set up the 11n communication period, the access point 2 transmits the CTS frame at the rate according to 802.11b to set the NAV to all the terminals 3 (time Tc). Then, the access point 2 transmits the CF-End frame at the rate according to 802.11n. As a result, only the third terminal 3-3 can transmit (time Td).

Then, in order to set up the 11g communication period again, the access point 2 transmits the CTS frame at the rate according to 802.11b to set the NAV for all terminals 3 (time Te). Then, the access point 2 transmits the CF-End frame at the rate according to 802.11g to lift the NAV from the terminal 3-2 and 3-3. Then, the access point 2 transmits the CTS frame at the rate according to 802.11n. As a result, only the second terminal 3-2 can transmit (time Tf).

Then, in order to set up the 11b communication period, the access point 2 transmits the CTS frame at the rate according to 802.11b to set the NAV to all the terminals 3 (time Tg). Then, the access point 2 transmits the CF-End frame at the rate according to 802.11b to lift the NAV from the terminals 3-1 to 3-3. Then, the access point 2 transmits the CTS frame at the rate according to 802.11g. As a result, only the first terminal 3-1 can transmit (time Th).

Then, in order to set up the 11g communication period again, the access point 2 transmits the CTS frame at the rate according to 802.11b to set the NAV for all terminals 3 (time Ti). Then, the access point 2 transmits the CF-End frame at the rate according to 802.11g to lift the NAV from the terminals 3-2 and 3-3. Then, the access point 2 transmits the CTS frame at the rate according to 802.11n. As a result, only the second terminal 3-2 can transmit (time Tj). The process described so far is repeated after this.

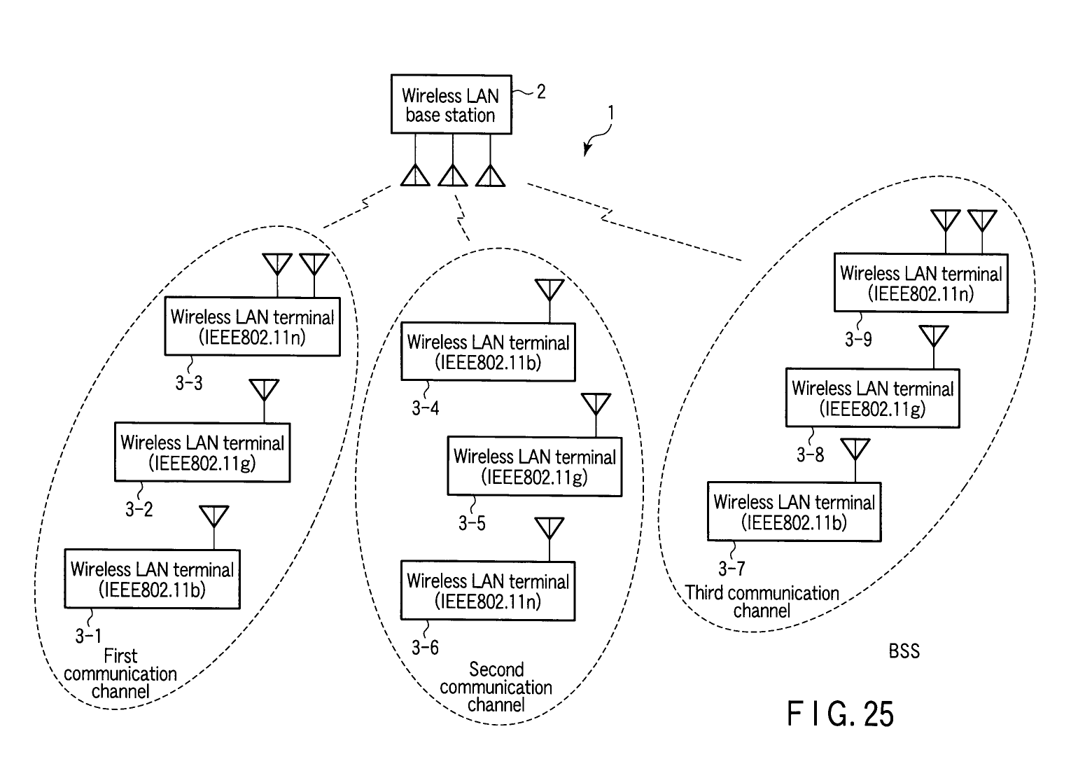

Furthermore, it is possible to provide sets each consisting two or three terminals like the first to third embodiments. For this purpose, for example, the terminal belonging to each set is configured to be able to communicate only by the communication channel of a frequency band exclusive to the set in question. This example is described with reference to FIG. 25.

FIG. 25 is a block diagram of the wireless LAN system according to a modified third embodiment. As shown, the access point 2 constitutes the BSS with the terminal 3-1 to 3-9 accommodated by it. In the following description, the terminals 3-1 to 3-9 may be referred to as first to ninth terminals 3-1 to 3-9, respectively. The configuration of the access point 2 is as described for the first embodiment except for the capability using the first to third communication channels in parallel for communication. Therefore, all the components (each functional block) in the access point 2 are configured to be able to simultaneously perform three types of processing for the communication channels. Alternatively, the whole set of components may be provided for each communication channel.

The access point 2 can use the first to third communication channels to communicate. The first terminal 3-1, second terminal 3-2, and third terminal 3-3 can use the first communication channel to communicate, and cannot use the second or third communication channels to communicate. The fourth terminal 3-4, fifth terminal 3-5, and sixth terminal 3-6 can use the second communication channel to communicate, and cannot use the first or third communication channels to communicate. The seventh terminal 3-7, eighth terminal 3-8, and ninth terminal 3-9 can use the third communication channel to communicate, and cannot use the first or second communication channels to communicate.

The third terminal 3-3, sixth terminal 3-6, and ninth terminal 3-9 support the communication schemes specified by IEEE 802.11n, IEEE 802.11g, and IEEE 802.11b. The second terminal 3-2, fifth terminal 3-5, and eighth terminal 3-8 support the communication schemes specified by IEEE 802.11g and IEEE 802.11b. The first terminal 3-1, fourth terminal 3-4, and seventh terminal 3-7 support only the communication scheme specified by IEEE 802.11b.

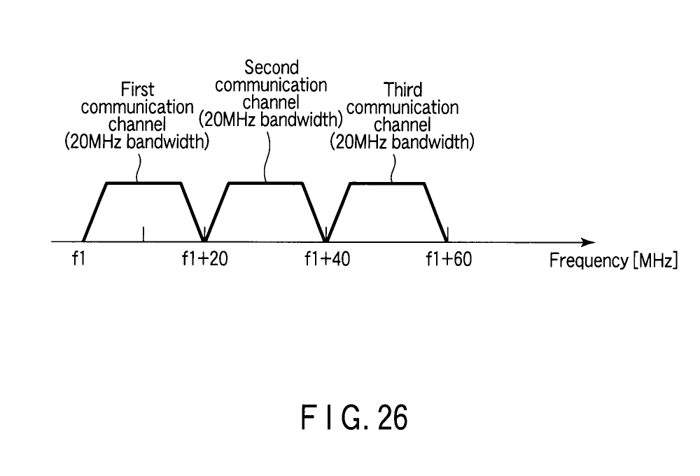

FIG. 26 shows the frequency bands used by the first to third communication channels. As shown, the first communication channel uses the bandwidth which ranges from the frequency f1 to (f1+20) MHz. The second communication channel uses the bandwidth which ranges from the frequency (f1+20) to (f1+40) MHz. The third communication channel uses the bandwidth which ranges from the frequency (f1+40) to (f1+60) MHz. Communication channels do not overlap, and restrictions such as SIFS are independently effective for each communication channel.

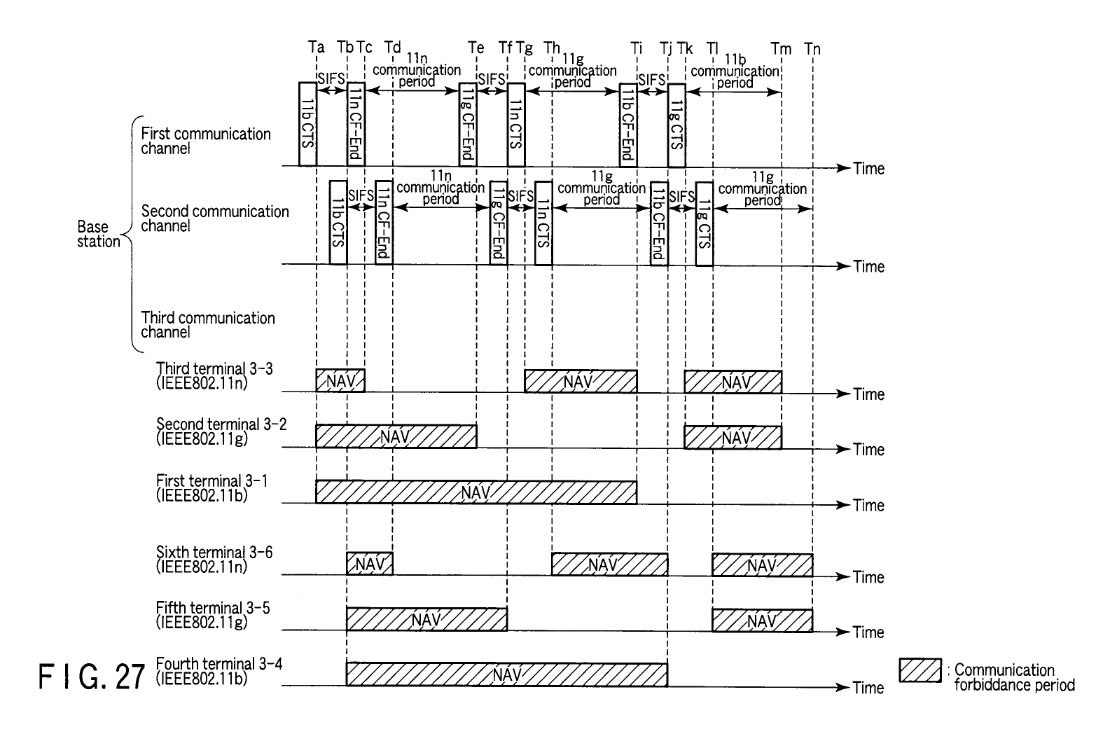

FIG. 27 is a timing chart showing the access point 2 of the system of FIG. 25, and the operational flow of the terminal 3.

The first controller 20 transmits the CTS frame at the rate specified by 802.11b in the first communication channel (time Ta). This CTS frame can be received by all the terminals 3-1 to 3-3 which support the first communication channel. By this CTS frame, the NAV is set for all the terminals 3-1 to 3-3 which support the first communication channel. Then, the second controller 22 transmits the CF-End frame at the rate according to 802.11n in the first communication channel. As a result, only the third terminal 3-3 can transmit in the first communication channel (time Tc).

In parallel with the setup of the 11n communication period in the first communication channel, the access point 2 sets up the 11n communication period in the second communication channel. For this purpose, the first controller 20 transmits the CTS frame at the rate specified by 802.11b in the second communication channel (time Tb). This CTS frame can be received by all the terminals 3-4 to 3-6 which support the second communication channel. By this CTS frame, the NAV is set for all the terminals 3-4 to 3-6 which support the second communication channel. Then, the second controller 22 transmits the CF-End frame at the rate according to 802.11n in the second communication channel. As a result, only the sixth terminal 3-6 can transmit in the second communication channel (time Td). The time Tb precedes the time Tc, and the time Tc precedes the time Td.

Then, in each of the first and second communication channels, the 11g communication period and 11b communication period are set up similarly. Specifically, the setup is as follows. First, the second controller 21 transmits the CF-End frame at the rate according to 802.11g in the first communication channel after the elapse of the 11n communication period in the first communication channel. As a result, the NAV of the second terminal 3-2 is lifted (time Te). The second controller 21 transmits the CF-End frame at the rate according to 802.11g in the second communication channel after the elapse of the 11n communication period in the second communication channel. As a result, the NAV of the fifth terminal 3-5 is lifted (time Tf).

Then, the third controller 22 transmits the CTS frame at the rate specified by 802.11n in the first communication channel. As a result, only the second terminal 3-2 can transmit in the first communication channel (time Tg). Then, the third controller 22 transmits the CTS frame at the rate specified by 802.11n in the second communication channel. As a result, only the fifth terminal 3-5 can transmit in the second communication channel (time Th).

The second controller 21 transmits the CF-End frame at the rate according to 802.11b in the first communication channel after lapse of the 11g communication period in the first communication channel. As a result, the NAV of the first terminal 3-1 is lifted (time Ti). The second controller 21 transmits the CF-End frame at the rate of 802.11b in the second communication channel after the elapse of the 11g communication period in the second communication channel. As a result, the NAV of the fourth terminal 3-4 is lifted (time Tj).

Then, the third controller 22 transmits the CTS frame at the rate according to 802.11g in the first communication channel. As a result, only the first terminal 3-1 can transmit in the first communication channel (time Tk). Then, the third controller 22 transmits the CTS frame at the rate according to 802.11g in the second communication channel. As a result, only the first terminal 3-4 can transmit in the second communication channel (time T1).

Furthermore, in the third communication channel, the 11n communication period, 11g communication period, and 11b communication period are also set up by the same process as described above for the first and second communication channels independently from the process in the first and second communication channels.

FIG. 20 shows a modified fourth embodiment and frame sequence for setting up exclusive communication periods in order of 40 MHz, 20 MHz, and 80 MHz.

First, in order to set up the 40-MHz communication period, the access point 2 uses the first communication channel to transmit the CTS frame to set the NAV for all the terminals 3 (time Ta). Then, the access point 2 uses the second communication channel to transmit the CF-End frame to lift the NAV from the terminals 3-2 and of 3-3. Then, the access point 2 uses the third communication channel to transmit the CTS frame. As a result, only the second terminal 3-2 can transmit (time Tb).

Then, in order to set up the 20-MHz communication period, the access point 2 uses the first communication channel to transmit the CTS frame to set the NAV for all the terminals 3 (time Tc). Then, the access point 2 uses the first communication channel to transmit the CF-End frame to lift the NAV from the terminal 3-1 to 3-3. Then, the access point 2 uses the second communication channel to transmit the CTS frame. As a result, only the first terminal 3-1 can transmit (time Td).

Finally, in order to set up the 80-MHz communication period, the access point 2 uses the first communication channel to transmit the CTS frame to set the NAV for all the terminals 3 (time Te). Then, the access point 2 uses the third communication channel to transmit the CTS frame. As a result, only the third terminal 3-3 can transmit (time Tf).

Although the figure is omitted, setup of exclusive communication periods in order of the MF communication period and GF communication period in the fifth embodiment can be performed in accordance with the above description.

Note that when the third embodiment is applied, for example to FIG. 9, the beacon frame transmitted at the time Ta sets the NAV for all the terminals 3, but this NAV is lifted by the subsequent transmission of the CF-End frame by the rate according to 802.11g. Therefore, the CTS frame at the time Tc and Te needs to be transmitted.

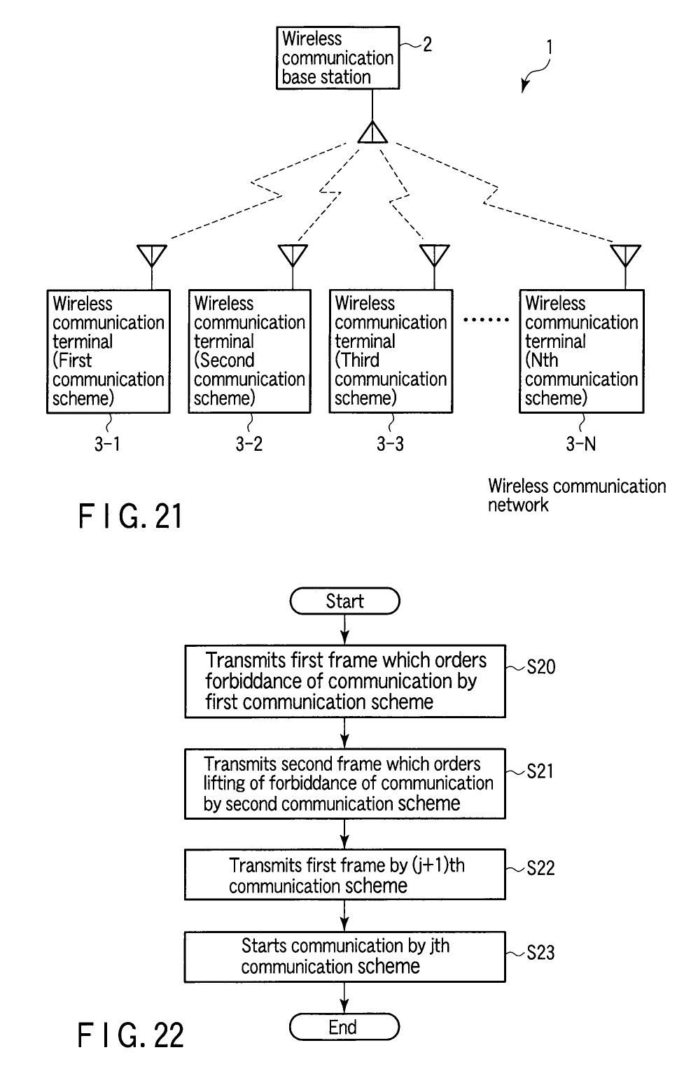

Namely, the embodiment can be described as follows. FIG. 21 shows the concept of the wireless communication network according to the embodiment. As shown, the wireless communication network 1 includes the wireless communication base station 2, and N wireless communication terminals 3-1 to 3-N (N being a natural number of two or more). Each of the N wireless communication terminals 3-1 to 3-N can transmit and receive data by the first to Nth communication schemes, respectively. The wireless communication base station can transmit and receive data by all the first to Nth communication schemes. Further, the i-th communication scheme (i being a natural number between two and N) has compatibility with the (i−1)th-or-lower communication schemes. The number of the wireless communication terminals 3-1 to 3-N may be one or more.

When the wireless communication base station 2 sets up an exclusive communication period for the j-th (j being a natural number of (N−1) or less) communication scheme of the first to Nth communication schemes, it executes processing according to the flowchart shown in FIG. 22. That is, the first controller 20 first transmits the first frame (the CTS frame) which orders the forbiddance of communication by the first communication scheme (step S20). The second controller 21 transmits the second frame (the CF-End frame) which orders the lifting of the forbiddance of communication by the jth communication scheme after the transmission of the first frame (step S21). The third controller 22 transmits the first frame by the (j+1)th communication scheme after the transmission of the second frame (step S22). After the transmission of the first frame by the (j+1)th communication scheme, communication by the jth communication scheme is performed (step S23).

Note that in order to set up an exclusive communication period for the Nth communication scheme, only the processing of the step S22 in FIG. 22 needs to be omitted because the Nth communication scheme is the highest communication scheme.

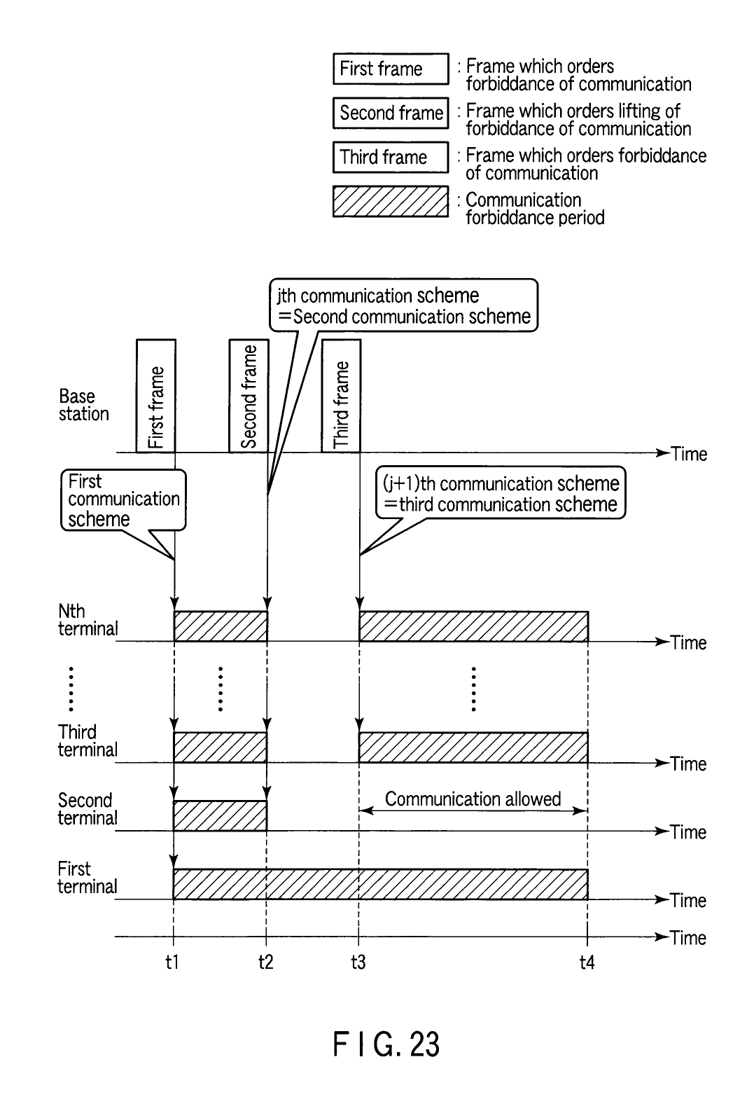

An illustrative processing according to FIG. 22 will be described with reference to FIG. 23, using as an example the case where an exclusive communication period for the second communication scheme is set up (j=2). FIG. 23 shows the frame sequence between the wireless communication base station 2 and the wireless communication terminals 3-1 to 3-N. The wireless communication terminals 3-1 to 3-N are referred to as the first to Nth terminals 3-1 to 3-N, respectively. The hatching in the figure is a communication forbiddance period (for example, period in which the NAV is set up).

As shown, the first frame is transmitted at the time t1 by the first communication scheme. This prohibits communication of the first to Nth terminals 3-1 to 3-N. Then, the second frame is transmitted at the time t2 by the second (=jth) communication scheme. This lifts the forbiddance of communication by the second to Nth terminals 3-2 to 3-N. However, the ban on the communication of the first terminal 3-1 is maintained. Finally, the first frame is transmitted at the time t3 by the third (=(j+1)th) communication scheme.

This prohibits the communication of the third to Nth terminals 3-3 to 3-N. As a result, only the second terminal 3-2 can communicate.

In the case of j=1, i.e., in order to set up an exclusive communication period for the lowest communication scheme, steps S20 and S21 can be skipped. For example, in FIG. 20, the transmission of the CTS frame at the time Tc and the following transmission of the CF-End can be omitted. However, it is desirable for simplification of the design to set up each exclusive communication period by use of the same setting principle. For this reason, even for setting up an exclusive communication period for the lowest communication scheme, it is desirable to perform steps S20 and S21.

The wireless communication system to which the embodiments are applied may constitute an infrastructure mode network which consists of a base station and several terminals or an ad hoc mode network where terminals directly communicate without a base station. Although it is illustrated that the setup of the exclusive communication period of the embodiments is performed by the base station, it may be performed by the terminals. The configuration of the terminal may be the same as the access point 2 in the above description with reference to FIG. 2.

The present invention is not limited to the embodiments described herein and can be variously modified at the practical stages as long as it does not deviate from the essence. Embodiments include inventions at various stages, and various inventions can be extracted from appropriate combinations of the components disclosed herein. For example, even if some components are omitted from all the components shown in the embodiments, if the problem indicated herein can be solved and the advantage presented herein can be obtained, the configuration obtained without these components can be extracted as an invention.

Additional advantages and modifications will readily occur to those skilled in the art. Therefore and the invention in its broader aspects is not limited to the specific details and representative embodiments shown and described herein. Accordingly and various modifications may be made without departing from the spirit or scope of the general inventive concept as defined by the appended claims and their equivalents.

What is claimed is:

1. A wireless communication device comprising:
a physical layer protocol processor which is able to transmit and receive data by first to Nth communication schemes (N being a natural number of two or more), an ith communication scheme (i being a natural number between two and N) having compatibility with the first to (i−1)th communication schemes;
a first controller which generates a first frame for forbidding communication by the first to Nth communication schemes for a first period, and orders the physical layer protocol processor to transmit the first frame by the first communication scheme;
a second controller which generates a second frame for lifting the forbiddance on communication by the first frame, and orders the physical layer protocol processor to transmit the second frame by a jth communication scheme (j being a natural number of N−1 or less); and
a third controller which generates a third frame for forbidding communication by (j+1)th to Nth communication schemes for a second period, and orders the physical layer protocol processor to transmit the third frame by the (j+1)th communication scheme.

2. The device according to claim 1, wherein
The ith communication scheme is defined as that a communication device which is able to transmit and receive data by the ith communication scheme is able to transmit and receive data by the first to ith communication schemes and is not able to transmit and receive data by (i+1)th to Nth communication schemes.

3. The device according to claim 1, wherein
the second period is a period in which communication by the jth communication scheme takes place.

4. The device according to claim 3, wherein
the first period is the total time of an SIFS period, a period for transmitting the second frame, the SIFS period, a period for transmitting the third frame, and the second period.

5. The device according to claim 1, wherein
the second frame is transmitted after the elapse of a SIFS period from completion of transmission of the first frame.

6. The device according to claim 1, wherein
the third frame is transmitted after the elapse of a SIFS period from completion of the transmission of the first frame.

7. The device according to claim 1 further comprising a schedule manager which determines a duration of the first period and a duration of the second period, and notifies the determined durations to the first and third controllers.

8. The device according to claim 1, wherein
the first communication scheme uses a bandwidth of 20 MHz, and
the second communication scheme uses a bandwidth of 40 MHz including the bandwidth of 20 MHz used by the first communication scheme.

9. The device according to claim 1, wherein
in order to communicate by the Nth communication scheme, the first controller generates the first frame and orders the physical layer protocol processor to transmit the first frame by the first communication scheme, then the second controller generates the second frame and orders the physical layer protocol processor to transmit the second frame by the Nth communication scheme, and the third controller does not operate.

10. The device according to claim 1, wherein
the physical layer protocol processor is able to communicate by the first to Nth communication schemes in a first communication channel, and to communicate by the first to Nth communication schemes in a second communication channel independently from communication in the first communication channel, and
the first communication channel uses a frequency bandwidth which does not overlap with a frequency bandwidth used by the second communication channel.

11. A wireless communication method performed in wireless communication devices which are able to communicate by first to Nth communication schemes (N being a natural number of two or more), an ith communication scheme (i being a natural number between two and N) having compatibility with the first to (i−1)th communication schemes, the method comprising:
transmitting a first frame for forbidding communication by the first communication scheme;
after the transmission of a first frame, transmitting a second frame for lifting the forbiddance of communication by a jth communication scheme (j being a natural number of N−1 or less);
after the transmission of a second frame, transmitting the first frame by a (j+1)th communication scheme; and
after the transmission of a first frame by a (j+1)th communication scheme, communicating by the jth communication scheme.

12. The method according to claim 11, wherein
The ith communication scheme is defined as that a communication device which is able to transmit and receive data by the ith communication scheme is able to transmit and receive data by the first to ith communication schemes and is not able to transmit and receive data by a (i+1)th to Nth communication schemes.

13. The method according to claim 11, wherein
the second period is a period in which communication by the jth communication scheme takes place.

14. The method according to claim 13, wherein
the first period is the total time of an SIFS period, a period for transmitting the second frame, the SIFS period, a period for transmitting the third frame, and the second period.

15. The method according to claim 11, wherein
the second frame is transmitted after the elapse of a SIFS period from completion of transmission of the first frame.

16. The device according to claim 11, wherein
the third frame is transmitted after the elapse of a SIFS period from completion of the transmission of the first frame.

17. The method according to claim 11, wherein
the first communication scheme uses a bandwidth of 20 MHz, and
the second communication scheme uses a bandwidth of 40 MHz including the bandwidth of 20 MHz used by the first communication scheme.

18. The method according to claim 11 further comprising:
transmitting a third frame for forbidding communication by the first communication scheme;
after the transmission of a third frame, transmitting a fourth frame for lifting the forbiddance of communication by the Nth communication scheme; and
after the transmission of a fourth frame, communicating by the Nth communication scheme.

19. The method according to claim 11, in parallel with the transmission of a first frame by the first communication scheme, the transmission of a second frame by a jth communication scheme, the transmission of the first frame by a (j+1)th communication scheme, and the communication by the jth communication scheme all in the first communication channel, the method further comprising:
transmitting a first frame by the first communication scheme in a second communication channel, the first communication channel using a frequency band which does not overlap with a frequency band used by the second communication channel;
after the transmission of a first frame in a second communication channel, transmitting a second frame for lifting the forbiddance of communication by a jth communication scheme (j being a natural number of N−1 or less) in the second communication channel;
after the transmission of a second frame in the second channel, transmitting the first frame by a (j+1)th communication scheme in the second communication channel; and
after the transmission of the first frame by a (j+1)th communication scheme in the second communication channel, communicating by the jth communication scheme in the second communication channel.
